(19) United States
(12) Patent Application Publication
(10) Pub. No.: US 2002/0065912 A1
(43) Pub. Date: May 30, 2002

(54) Web session collaboration

(76) Inventors: Lawrence W. Catchpole, Roswell, GA (US); Joseph K. Vossen, Duluth, GA (US); Eugene S. Briski, Alpharetta, GA (US); Jeffrey S. Barber, Suwanne, GA (US); Andrew Gingher, Roswell, GA (US); Michael Stittleburg, Kennsaw, GA (US)

Correspondence Address: Jack D. TODD, MORRIS, MANNING & MARTIN, LLP, Suite 1125, 6000 Fairview Road, Charlotte, NC, 28210, US

(21) Appl. No.: 10/002,662

(22) Filed: Nov. 30, 2001

Related U.S. Application Data
(60) Provisional application No. 60/250,300, filed on Nov. 30, 2000.

(51) Int. Cl. G06F 15/16; G06F 15/173

(52) U.S. Cl. 709/224; 709/227; 707/104.1; 713/168; 709/204

(57) ABSTRACT

A method of monitoring browser interactions with a server arrangement includes: capturing information regarding requests and corresponding responses; identifying sessions, each session including requests received at the server arrangement and corresponding responses; assigning a session identification (SessionID) for each identified session; recording in a database the SessionID, the content of each respective request in the session, the content of each corresponding response, and a chronological order of the requests; and re-creating selected pages representative of a particular browser's interactions and identifying browsing patterns.

### CROSS REFERENCE TO RELATED APPLICATION

This application claims the benefit under 35 U.S.C. § 119(e) of U.S. provisional patent application No. 60/250, 300, entitled, “Collaboration System, ” filed Nov. 30, 2000, which is incorporated herein by reference.

### FIELD OF THE PRESENT INVENTION

The present invention relates generally to Internet or client/server communications and, more particularly, to a computerized system for enabling the capture and replay of a web session.

### BACKGROUND OF THE PRESENT INVENTION

The Internet provides companies with numerous opportunities for generating business and specifically provides such companies with another avenue for reaching customers or end users. Many web sites often have one or more enterprise applications accessible through the web site, which enable their customers to manage accounts and otherwise conduct business with or through the web site. For example, a financial institution or brokerage firm may have one or more enterprise applications accessible through its web site, which enable its customers to view account information, reconcile accounts, pay bills, transfer money, buy or sell securities, and the like. In another example, the web site of an on-line merchant may have an enterprise application accessible through its web site that enables its customers to view and search for merchandise and pay for the same using a credit card previously-provided to the online merchant so that the customer does not have to re-enter payment information on every visit to the web site.

Unfortunately, not all customers or end users are computer-savvy or comfortable doing business, placing orders, or filling out forms over the Internet or on a web site. In addition, if an end user has difficulty interacting with the web site or with the enterprise application accessible through the web site, there is generally no human being with which the end user is able to interact during the web session.

Requesting help via the web site's “help” web page may not be all that helpful because it typically provides generalized pointers or guidelines for the most common problems experienced by others on the web site but it may not be pertinent or helpful to the end user in a specific instance. Further, preparing and sending an email to the web site's operator or to the customer service department supporting the enterprise application may ultimately be helpful; however, such a process is often frustrating for the customer if a response is not received immediately. In some circumstances, especially for on-line merchants, it may be easier for the end user to move on to a competitor's web site to receive the goods or service being sought rather than take the time to generate an email and wait for an email response from a customer service representative (CSR) associated with the web site. Furthermore, the CSR may or may not be able to determine exactly what problem the end user is or was having—depending on the end user's ability to describe accurately in the email the issue or problem.

For these and many other reasons, there is a general need for the ability to capture and replay a web session of an end user.

Further, there is a need for a system or method in which CSRs are able to guide an end user through a process on the web site in near-real-time while the end user is actually visiting the web site or accessing an enterprise application through the web site to facilitate efficient problem resolution and to make the visit to the web site by the end user more pleasant and productive. Further, there is a need for such a system in which a CSR is able to retrace the steps and actions of an end user off-line or in-near-real-time to determine what the end user needs help with, what goods or services may be of interest to the end user or desirable to provide to the end user, or how the web site and enterprise application is functioning.

There is a need for a system in which CSRs are able to view “before and after” web pages, including highlighted form entries, so that the CSR is able to identify quickly any potential errors in the end user's data input or form entry.

There is a need for a system or method that provides CSRs with a comprehensive view of an end user's entire web session, including all communications between the end user and the web site.

Further, there is a need for such a system or method that provides non-repudiation capabilities for transactions and agreements entered into by an end user during the visit to the web site.

There is a need for a system or method that is capable of analyzing an end user's web session to determine if the end user is engaging in a particular pattern of behavior or activity that provides a potential cross-selling opportunity or that indicates that follow-up from a CSR or sales representative is necessary or desirable from the entity's standpoint even if the end user does not request help or seek assistance.

Further, there is a need for such a system or method that does not require end users to install or download additional software or plug-ins (other than a conventional browser) on their computers in order to receive the above benefits and services.

The present invention meets one or more of the above-referenced needs as described herein in greater detail.

### SUMMARY OF THE PRESENT INVENTION

The present invention generally to Internet or client/server communications and, more particularly, to a computerized system for enabling the capture and replay of a web session. Briefly described, aspects of the present invention include the following:

In a first aspect of the present invention, a method for monitoring a browser's interactions with a server arrangement, includes the steps of: (a) capturing information regarding http requests received at the server arrangement and corresponding http responses sent from the server arrangement, the information including, (i) for each request, content of the request and a time of receipt for the request, and (ii) content of the response corresponding to each such request; (b) identifying sessions, each including requests received at the server arrangement and corresponding responses; (c) assigning a session identification (SessionID) for each identified session; and (d) recording in a database for each identified session the SessionID for such session in association with, (i) the content of each respective request in the identified session, (ii) the content of each respective response in the identified session, and (iii) a chronological order of the requests in the identified session.

In a second aspect of the present invention, a method for monitoring browser interactions with a server arrangement, includes the steps of: (a) capturing information regarding http requests received from browsers at the server arrangement and corresponding http responses sent to the browsers from the server arrangement, the information including, (i) for each request, (A) content of the request, (B) a time of receipt for the request, and (C) a browser identification (BrowserID) associated with the request, and (ii) content of the response corresponding to each such request, and (b) identifying sessions for each BrowserID, each session including requests associated with such BrowserID that are received at the server arrangement within a predetermined period of time and corresponding responses; (c) assigning a session identification (SessionID) for each identified session; and (d) recording in a database for each identified session the SessionID for such session in association with, (i) the content of each respective request in the identified session, (ii) the content of each respective response in the identified session, (iii) a chronological order of the requests in the identified session, and (iv) the BrowserID for which the session is identified.

In a third aspect of the present invention, a method for monitoring browser interactions with a server arrangement for a website, includes the steps of: (a) capturing information regarding http requests received from browsers at the server arrangement and corresponding http responses sent to the browsers from the server arrangement, the information including, (i) for each request, (A) content of the request, (B) a time of receipt for the request, (C) a browser identification (BrowserID) associated with the request, and (D) an entity identification (EntityID) associated with a uniform resource locator (URL) related to the request, and (ii) content of the response corresponding to each such request; (b) identifying sessions for each pair of BrowserID and EntityID, each session including, (i) requests associated with such BrowserID and related to the URL associated with the EntityID that are received at the server arrangement within a predetermined period of time, and (ii) corresponding responses; (c) assigning a session identification (SessionID) for each identified session; and (d) recording in a database for each identified session the SessionID for such session in association with, (i) the content of each respective request in the identified session, (ii) the content of each respective response in the identified session, (iii) a chronological order of the requests in the identified session, and (iv) the BrowserID and EntityID for which the session is identified.

In a fourth aspect of the present invention, a method of creating content of a response enabling a browser to generate a page from information recorded in a database regarding past browser interactions with a server arrangement, the browser interactions including primary and subordinate http requests received at the server arrangement and corresponding primary and subordinate http responses sent from the server arrangement, the information including (i) for each request, content of the request and, in association therewith, content of the response corresponding to such request, and (ii) a chronological order of the requests received at the server arrangement, includes the steps of: (a) parsing the content of a primary response recorded in the database to identify uniform resource locators (URLs) contained therein, and (b) for a URL so identified, locating in the content recorded in the database of subordinate requests received at the server arrangement prior to the next primary request a URL matching the identified URL, and upon a match, replacing the identified URL in the content of the primary response with a database pointer directed to the content recorded in the database for the subordinate response corresponding to such sub ordinate request having the matching URL.

In a fifth aspect of the present invention, a method of creating content of a response enabling a browser to generate a page from information recorded in a database regarding past browser interactions with a server arrangement, the browser interactions including primary and subordinate http requests received at the server arrangement from browsers and corresponding primary and subordinate http responses sent from the server arrangement to the browsers, the page representative of past browser interactions of a particular browser, the information recorded in the database including (i) for each request, content of the request and, in association therewith, content of the response corresponding to such request and a browser identification (BrowserID) for the request, the BrowserID being unique to a browser, (ii) a chronological order of the requests received at the server arrangement, the method including the steps of: (a) parsing the content of a primary response recorded in the database to identify uniform resource locators (URLS) contained therein, the primary response being associated with the BrowserID of the particular browser; (b) for a URL so identified, locating in the content recorded in the database of subordinate requests received at the server arrangement prior to the next primary request a URL matching the identified URL, and upon a match, replacing the identified URL in the content of the primary response with a database pointer directed to the content recorded in the database for the subordinate response corresponding to such subordinate request having the matching URL.

In a sixth aspect of the present invention, a method of viewing a page representative of past browser interactions of a particular browser with a server arrangement, includes the steps of. (I) monitoring browser interactions of a plurality of browsers, including the particular browser, with the server arrangement, including, (a) capturing information regarding primary and subordinate http requests received from the browsers at the server arrangement and corresponding primary and subordinate http responses sent to the browsers from the server arrangement, the information including, (i) for each request, (A) content of the request, (B) a time of receipt for the request, and (C) a browser identification (BrowserID) associated with the request, the BrowserID being unique to each browser, and (ii) content of the response corresponding to each such request, and (b) identifying sessions for each BrowserID, each session including requests associated with such BrowserID that are received at the server arrangement within a predetermined period of time and corresponding responses; (c) assigning a session identification (SessionID) for each identified session; and (d) recording in a database for each identified session the SessionID for such session in association with, (i) the content of each respective request in the identified session, (ii) the content of each respective response in the identified session, (iii) a chronological order of the requests in the identified session, and (iv) the BrowserID for which the session is identified; (II) creating content of a response, including, (a) parsing the content of a primary response recorded in the database to identify uniform resource locators (URLs) contained therein, the primary response being associated with the BrowserID of the particular browser; and (b) for a URL so identified, locating in the content recorded in the database of subordinate requests received at the server arrangement prior to the next primary request a URL matching the identified URL, and upon a match, replacing the identified URL in the content of the primary response with a database pointer directed to the content recorded in the database for the subordinate response corresponding to such subordinate request having the matching URL; and (III) sending the created content of the response to a reviewing browser for generation of the page.

In a seventh aspect of the present invention, a method of rendering assistance by a customer service representative (CSR) to a user of a particular browser interacting with a web server arrangement, includes the steps of, (I) monitoring browser interactions of a plurality of browsers, including the particular browser, with the server arrangement, including, (a) capturing information regarding primary and subordinate http requests received from the browsers at the server arrangement and corresponding primary and subordinate http responses sent to the browsers from the server arrangement, the information including, (i) for each request, (A) content of the request, (B) a time of receipt for the request, and (C) a browser identification (BrowserID) associated with the request, the BrowserID being unique to each browser, and (ii) content of the response corresponding to each such request, and (b) identifying sessions for each BrowserID, each session including requests associated with such BrowserID that are received at the server arrangement within a predetermined period of time and corresponding responses; (c) assigning a session identification (SessionID) for each identified session; and (d) recording in a database for each identified session the SessionID for such session in association with, (i) the content of each respective request in the identified session, (ii) the content of each respective response in the identified session, (iii) a chronological order of the requests in the identified session, and (iv) the BrowserID for which the session is identified; (II) viewing by the CSR on a CSR browser a page representative of past browser interactions of the particular browser of the user with the server arrangement, including the steps of: (a) creating content of a response, including, (i) parsing the content of a primary response recorded in the database to identify uniform resource locators (URLs) contained therein, the primary response being associated with the BrowserID of the particular browser; and (ii) for a URL so identified, locating in the content recorded in the database of subordinate requests received at the server arrangement prior to the next primary request a URL matching the identified URL, and upon a match, replacing the identified URL in the content of the primary response with a database pointer directed to the content recorded in the database for the subordinate response corresponding to such subordinate request having the matching URL; and (b) displaying the page on the CSR browser upon receipt by the CSR browser of a response having the created content; and (III) providing guidance by the CSR to the user based on the viewing of the page by the CSR.

In an eighth aspect of the present invention, A method for monitoring a browser's interactions with a server arrangement, includes the steps of (a) capturing information regarding primary and subordinate http requests received at the server arrangement and corresponding primary and subordinate http responses sent from the server arrangement, the information including, (i) for each request, content of the request, and (ii) content of the response corresponding to each such request; (b) recording in a database, (i) the content of each respective request, (ii) the content of each respective response, and (iii) a chronological order of the requests; (c) parsing the content of primary requests recorded in the database to identify uniform resource locators (URLs) contained therein; and (d) taking a predefined action in response to the recognition of a predetermined pattern of identified URLs contained with the content of the primary requests.

In a ninth aspect of the present invention, method for monitoring a browser's interactions with a server arrangement, including the steps of (a) capturing information regarding primary and subordinate http requests received at the server arrangement and corresponding primary and subordinate http responses sent from the server arrangement, the information including, (i) for each request, content of the request and a time of receipt for the request, and (ii) content of the response corresponding to each such request; and (b) identifying sessions, each including requests received at the server arrangement and corresponding responses; (c) assigning a session identification (SessionID) for each identified session; (d) recording in a database for each identified session the SessionID for such session in association with, (i) the content of each respective request in the identified session, (ii) the content of each respective response in the identified session, and (iii) a chronological order of the requests in the identified session; and (e) for a particular SessionID, parsing the content of primary requests recorded in the database in association with such SessionID to identify uniform resource locators (URLs) contained therein, and (f) taking a predefined action in response to the recognition of a predetermined pattern of identified URLs contained with the content of the primary requests.

In a tenth aspect of the present invention, a method for monitoring a browser's interactions with a server arrangement, including the steps of (a) capturing information regarding primary and subordinate http requests received at the server arrangement and corresponding primary and subordinate http responses sent from the server arrangement, the information including, (i) for each request, (A) content of the request, (B) a time of receipt for the request, and (C) a browser identification (BrowserID) associated with the request, and (ii) content of the response corresponding to each such request; (b) identifying sessions for each BrowserID, each including requests associated with such BrowserID that are received at the server arrangement within a predetermined period of time and corresponding responses; (c) assigning a session identification (SessionID) for each identified session; (d) recording in a database for each identified session the SessionID for such session in association with, (i) the content of each respective request in the identified session, (ii) the content of each respective response in the identified session, (iii) a chronological order of the requests in the identified session, and (iv) the BrowserID for which the session is identified; (e) for a particular BrowserID, parsing the content of primary requests recorded in the database in association with such BrowserID to identify uniform resource locators (URLs) contained therein; and (f) taking a predefined action in response to the recognition of a predetermined pattern of identified LTRLs contained with the content of the primary requests.

The present invention also encompasses computer-readable medium having computer executable instructions for performing methods of the present invention, and computer networks that implement the methods of the present invention.

Features of the present invention are disclosed and will become apparent from the following description of preferred embodiments of the present invention.

### BRIEF DESCRIPTION OF THE DRAWINGS

Further features and benefits of the present invention will be apparent from a detailed description of preferred embodiments thereof taken in conjunction with the following drawings, wherein similar elements are referred to with similar reference numbers, and wherein:

FIGS. 1a through 1i illustrate a sequence of events that take place during an exemplary web session transaction and web session collaboration using the system and methodology of the present invention.

FIG. 2 is an architectural overview of various components of the system of the present invention.

FIG. 2a is an alternative architectural overview of the various components of the system of FIG. 1.

FIG. 2b is yet another alternative architectural overview of the various components of the system of FIG. 1.

FIG. 3 is a flowchart of front end processes performed by various components of the system of FIG. 2.

FIG. 4 is a flowchart of back end processes performed by various components of the system of FIG. 2.

FIG. 5a is a high level flowchart of steps performed by a capture component of the system of FIG. 2.

FIG. 5b is a high level flowchart of steps performed by a collection component of the system of FIG. 2.

FIG. 5c is a high level flowchart of steps performed by a collaboration services component and a presentation component of the system of FIG. 2.

FIG. 6 is a more detailed flowchart of some of the steps performed by the capture component in FIG. 5a.

FIG. 7 is a more detailed flowchart of further steps performed by the capture component in FIG. 5a.

FIGS. 8a, 8b, and 8c are tables illustrating the data contained with capture elements of the present invention.

FIGS. 9a, 9b, and 9c are a more detailed flowchart of the steps performed by the collection component in FIG. 5b.

FIGS. 10a, 10b, and 10c are tables illustrating session, request, and response data tables maintained in a database storage of the present invention.

FIG. 11 is a more detailed flowchart of some of the steps performed by the collaboration services and presentation components in FIG. 5c.

FIG. 12 is a table illustrating a sequence of primary and subordinate HTTP requests within a single web session of the present invention.

FIG. 13 is a flowchart of some of the steps performed by the collaboration services and presentation components in FIG. 11.

FIG. 14 is a flowchart of further steps performed by the collaboration services and presentation components in FIG. 11.

FIGS. 15a, 15b, 15c, and 15d are exemplary views of a computer interface of a CSR collaboration web session of the present invention.

FIG. 16 is a flowchart of yet further steps performed by the collaboration services and presentation components in FIG. 11.

FIG. 17 is an alternative architectural overview of various components of the system for another aspect of the present invention.

FIG. 18 is a flowchart of additional front end processes performed by various components of the system of FIG. 17.

FIG. 19 is a flowchart of additional back end processes performed by various components of the system of FIG. 17.

FIGS. 20, 20a are exemplary views of a computer interface of a web session customer playback session according to yet another aspect of the present invention.

FIG. 21 is a flowchart of alternative back end processes performed by various components of the system of FIGS. 20, 20a.

FIG. 22 is a flowchart of yet further alternative back end processes performed by various components of the system for another aspect of the present invention.

FIG. 23 is a high level flowchart of steps performed by the modified collaboration services component processes of the system of FIG. 22.

FIG. 24 is a high level flowchart of steps performed by the pattern recognition processes of the system of FIG. 22.

### DETAILED DESCRIPTION OF PREFERRED EMBODIMENTS

As used herein, the following terms have the following meanings:

Terminology

“Application” (or “affiliated application” or “enterprise application”) means the software program(s) operating on or accessible through an entity's web site and with which a customer or end user primarily interacts when accessing the entity's web site.

“Browser” (or “web browser”) refers to a program installed on a computer of an end user, which allows the end user to read HTML files and information embedded in hypertext links in these files. The browser enables the end user to view the contents of local and remote files and to navigate from one file to another using embedded hypertext links. A browser acts as a client to remote web servers. Examples of browsers that are commercially available include Netscape Navigator® and Microsoft Internet Explorer®.

“Click” refers to an end user's action of pressing a button on a mouse or other pointing device. This typically generates an event, also specifying the screen position of the cursor, which is then processed by a window manager or application program.

“Click-stream” refers to a subset of HTTP request/response pairs representing the end user's view of the application. Preferably, the click-stream holds only the HTTP request/response pairs corresponding to separate web pages (containing HTML source) viewed by an end user.

“Customer” (or “end user”) means an individual using a computer to interact with an entity's web site and application accessible through the web site.

“CSR” means a customer service representative of or acting on behalf of an entity and who provides technical support and assistance to end users accessing the entity's web site and/or enterprise application.

“End user” (or “customer”) means an individual using a computer to interact with an entity's web site and application accessible through the web site.

“Entity” refers to the organization on whose behalf the application, web server, as well as the collaboration system components are working.

“HTML” (or “html”), which means HyperText Markup Language, is the document format used on the World Wide Web. Generally, web pages are built with HTML tags (codes) embedded in the text. HTML defines the page layout, fonts, and graphic elements as well as the hypertext links to other documents on the Web. Each link contains the URL, or address, of a web page residing on the same server or any server worldwide. HTML is derived from SGML, the Standard Generalized Markup Language, which is widely used to publish documents. HTML is an SGML document with a fixed set of tags that, although change with each new revision, are not flexible. A subset of SGML, known as XML, allows the developer of the web page to define the tags. Currently, HTML 4.0 and XML 1.0 have been combined into a single format called “XHTML,” which is expected to become the standard format for web pages.

“HTTP” stands for HyperText Transport Protocol and is the communications protocol used to connect to servers on the World Wide Web. Its primary function is to establish a connection with a web server and transmit HTML pages to the client browser.

“Hypertext” refers to links embedded within web pages, which are addresses to other Web pages either stored locally or on a web server anywhere in the world. Links can be text only, in which case they are underlined, or they can be represented as an icon of any size or shape.

“Image” is the generic term for session content other than click-stream data. Typically, image data consists of jpeg, tiff, or gif format images.

“Login” refers to an HTTP request/response that effects (or potentially effects) a transition from the state where the end user is not identified to the state where the end user is identified.

“Plug-in” generally means an auxiliary program and/or hardware components that work with a primary software package to enhance its capability.

“Session” (or “web session”) refers to a connected series of HTTP requests and associated responses served to a single browser (representing the end user) by a single application and/or web server, usually within a brief period of time or at least without long periods without any interaction.

“URL”, which stands for Uniform Resource Locator, is an address that defines the route to a resource, such as a file or program, on the World Wide Web or any other Internet facility. URLs may typed into the browser to access web pages, embedded within the web pages themselves as hypertext links to other web pages, or embedded within the html source of a Web page to direct the browser to obtain request and obtain additional resources (such as graphics, etc.) to complete the originally-requested web page.

“Web host provider” means the organization operating the web server on behalf of the entity. In some case, the web host provider also operates the application and/or the components of the system of the present invention on behalf of the entity. In some cases, the web host provider and the entity are the same organization.

“Web server” refers to a computer that provides World Wide Web services on the Internet. It includes the hardware, operating system, web server software, TCP/IP protocols, and the web site content (web pages). Web browsers communicate with web servers via the TCP/IP protocol. The browser sends HTTP requests to the server, which responds with HTML pages and possibly additional program s, such as or in the form of ActiveX controls or Java applets.

“World Wide Web” (or “www” or “W3” or “the Web”) refers to the Internet or world-wide computer network system that links individual computers and servers together and enables the transfer of resources, such as documents, locally and remotely. Among other resources, a web page typically contains text, graphics, animations and videos as well as hypertext links. The hypertext links in the web page enable end users to “jump” from web page to web page (hypertext) whether the web pages are stored on the same web server or on web servers anywhere in the world. Web pages are accessed and read via a web browser.

Exemplary Web Session Transaction and Collaboration

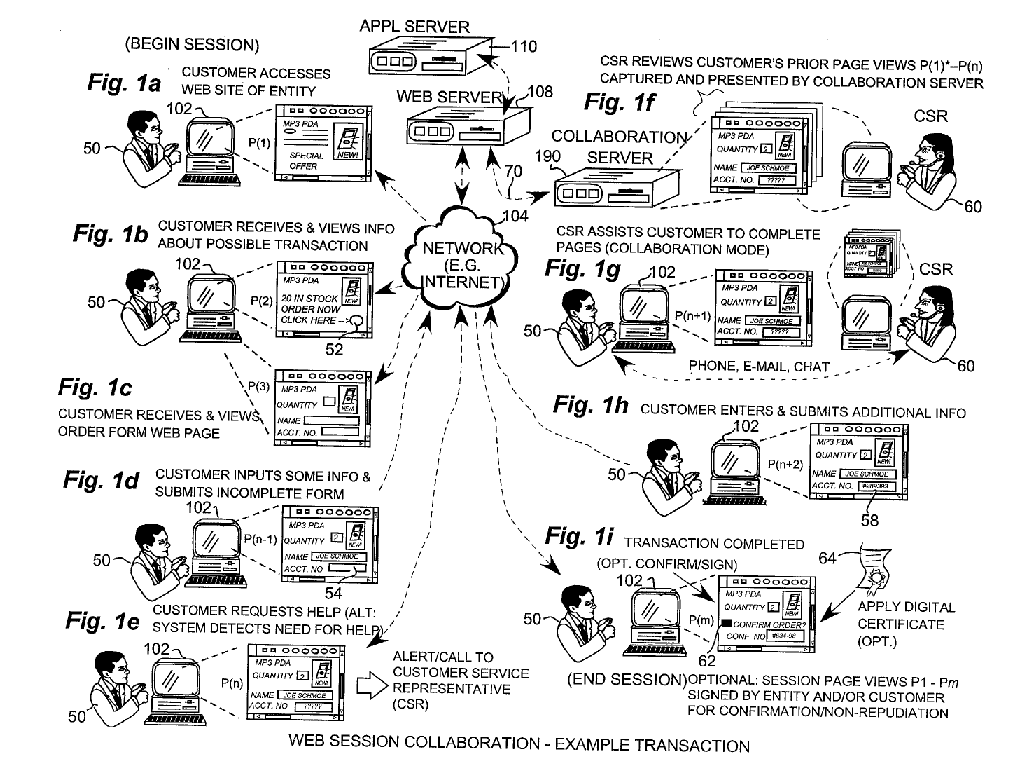

Through a sequence of illustrations, FIGS. 1a through 1i depict an exemplary web session transaction between a customer 50 (or end user) and a web site of an entity. The illustrations also depict a web session collaboration between the customer 50 and a CSR 60 of the entity. As shown in FIG. 1a, the customer 50, using computer 102, which has installed thereon web browser software, accesses the web site of the entity by communicating in conventional manner through the Internet or other communications network 104 with a web server 108. The web server 108 is in communication with an application server 110 of the entity, which enables the customer 50 to access, through the web site, enterprise applications, programs, and data of or maintained by the entity. A simplified version of the first web page P(1) of the web site accessed by the customer 50 is shown in FIG. 1a. The first web page P(1) illustrates an offer for sale of MP3 personal digital assistants (PDAs) by the entity.

Access to the entity's web site by the browser running on computer 102 is accomplished using HTTP network protocol. Usually HTTP takes place through TCP/IP sockets established between the computer 102 and the web server 108. HTTP is the protocol generally used to deliver files, documents, dynamically-generated query results, the output of a CGI script file, and other data (collectively called “resources”) on the World Wide Web, whether such resources are HTML files, image files, query results, multi-media files, and the like. Like most network protocols, HTTP uses the client/server model. For example, an HTTP client (e.g., the customer's browser running on computer 102) first opens a connection and sends a request to an HTTP server (e.g., web server 108). The HTTP server then returns a response, usually containing the resource that was requested. The HTTP server is able to maintain the association between a request and its response in conventional manner.

The format of a request typically includes: (a) an initial request line (containing an HTTP method, such as GET or POST, the local path (or URL) of the requested resource, and the version of HTTP being used), (b) zero or more headers, (c) a blank line (i.e., a carriage return, line feed (CR/LF)), and (d) an optional message body (e.g., a file, form data, query data, query output, and the like). The format of a response typically includes: (a) a status line (containing the HTTP version, a three-digit response status code, and an English “reason” code explaining the three-digit response status code), (b) zero or more headers, (c) a blank line (i.e., a carriage return, line feed (CR/LF)), and (d) the response body, which typically includes the resource requested by the end user.

As generally shown with reference to FIGS. 1a through 1i and in accordance with the present invention, requests from the customer 50 to the web server 108 and each corresponding response from the web server 108 to the customer 50 are captured by a plug-in (or similar hardware or software) (not shown) associated with web server 108 and provided (as shown by communication line 70) to a collaboration server arrangement 190 for processing and storage.

With specific reference to FIG. 1b, the customer 50 receives and views a second web page P(2), which, in this example, contains information about a possible transaction between the customer 50 and the entity. The customer 50 selects or activates the “click here” order button 52 to initiate the transaction.

In FIG. 1c, after selecting the “click here” order button 52 on web page P(2), the customer 50 receives and views a third web page P(3), which, in this example, contains a blank order form into which the customer 50 is able to input information to continue with the transaction.

In FIG. 1d, the customer 50 submits the information input into the blank order form to the web server. The filled-in form appears to the customer 50 as shown in web page P(n−1). Of particular note is the fact that the customer 50 has not input any information into the “Acct. No.” field.

In FIG. 1e, the web server 108 responds to the submittal of an incomplete form with web page P(n), which indicates (by the “?????”) that the customer 50 must input information into the “Acct. No.” field. At this point in the transaction and web session, the customer 50 requests help from the CSR 60. Such help may be requested by email, telephone call, or Internet chat in conventional manner. Alternatively, the web server 108 detects the customer's need for help and notifies the CSR 60 directly.

In FIG. 1f, the CSR 60 reviews the prior web pages 56 viewed by the customer 50, as they have been captured and re-created by the collaboration server arrangement 190. If the customer 50 was a previous visitor to the entity's web site, then the captured web pages include pages P(1) through P(n−1). For reasons that will become apparent later, if the customer 50 was not a previous visitor to the entity's web site and page P(1) was the first web page of the web site visited by the customer 50, then the captured web pages include pages P(2) through P(n−1). It should also be noted that the CSR 60 is able to review web page P(n) but only as it was sent by the web server 108. The CSR 60 is not able to see any modifications to any of the form input fields in web page P(n) made by the customer 50 until it is resubmitted by the customer 50 to the web server 108.

In FIG. 1g, the CSR 60 communicates with the customer 50 via email, telephone call, or Internet chat and assists the customer 50 in completing the form, which is depicted in web page P(n+1). It should be noted that the CSR 60 cannot view web page P(n+1) as it is being edited by the customer 50 since the information being input by the customer 50 has not yet been sent to the web server 108.

In FIG. 1h, the customer 50 inputs additional information 58 into the form, as shown by web page P(n+2), and submits the new form, now completed, to the web server 108.

In FIG. 1i, the transaction has been completed. The web server 108 responds either with a “confirmation” web page P(m), as shown, and/or with a follow-up “thank you for your order” web page (not shown). If the information shown on web page P(n+2), the customer 50 preferably confirms the transaction by activating the “confirm” button 62. Optionally, the customer 50 is provided with the capability of digitally signing the confirmation in conventional manner. The web server 108 can also digitally sign the transaction and include a digital certificate 64 therewith. When the customer 50 leaves the web site or formally logs-off from the web site, the web session ends.

In a further optional step occurring during or after the web session and collaboration described above in FIGS. 1a through 1i, the collaboration server arrangement 190 transmits the series of “captured” web pages P(1) or P(2), as the case may be, through P(m) to the customer 50 for review by the customer 50 for confirmation purposes and, if digitally signed by the customer 50, for non-repudiation purposes.

In a further optional step, occurring during but, more likely, after the web session and collaboration described above in FIGS. 1a through 1i, the collaboration server arrangement 190 internally creates a message digest of each record of data used to generate a replay of the web session and digitally signs each message digest to create a reliable log of the web session. If it later becomes necessary to re-create the web session from the database records at a later date, the collaboration server arrangement 190 ensures that the later re-creation is accurate by comparing a newly-computed hash value of each record used to generate the re-creation with the bash value recovered from the digital signature for each corresponding record recovered from the database.

Although the above example of a web session transaction and collaboration in FIGS. 1a through 1i takes place between a customer 50 and a web server 108 over the Internet 104, it should be understood that, in other examples not shown, the communication may just as likely occur between an end user and a CSR over an intranet or other dedicated network.

System Architectural Overview

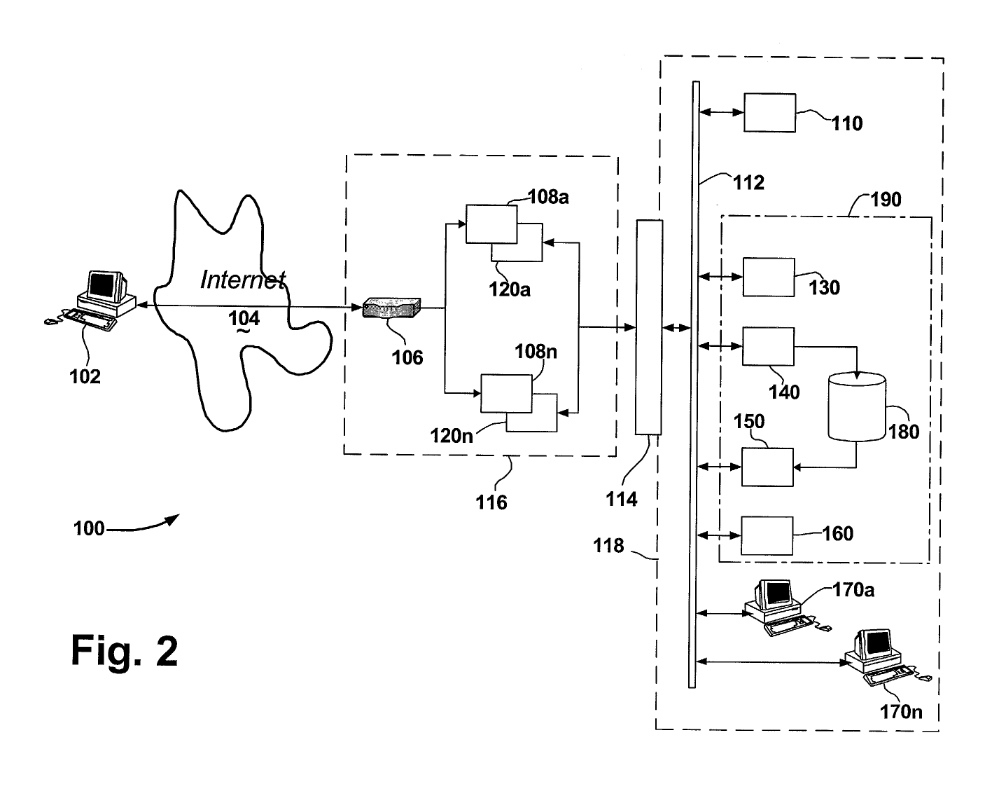

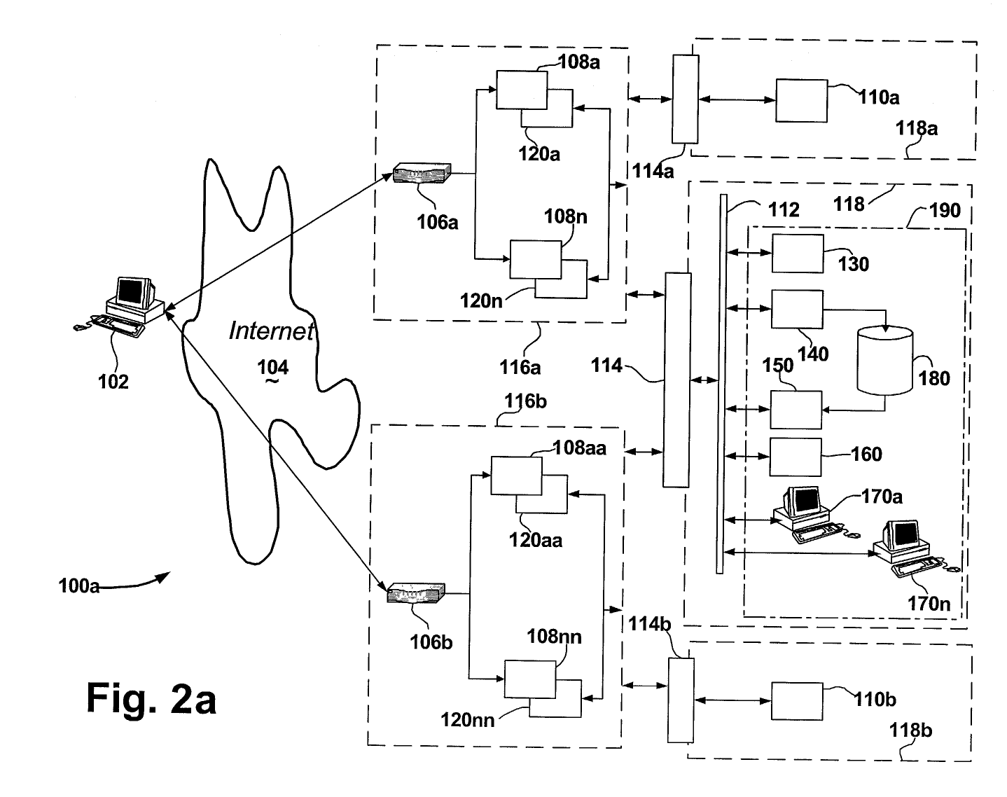

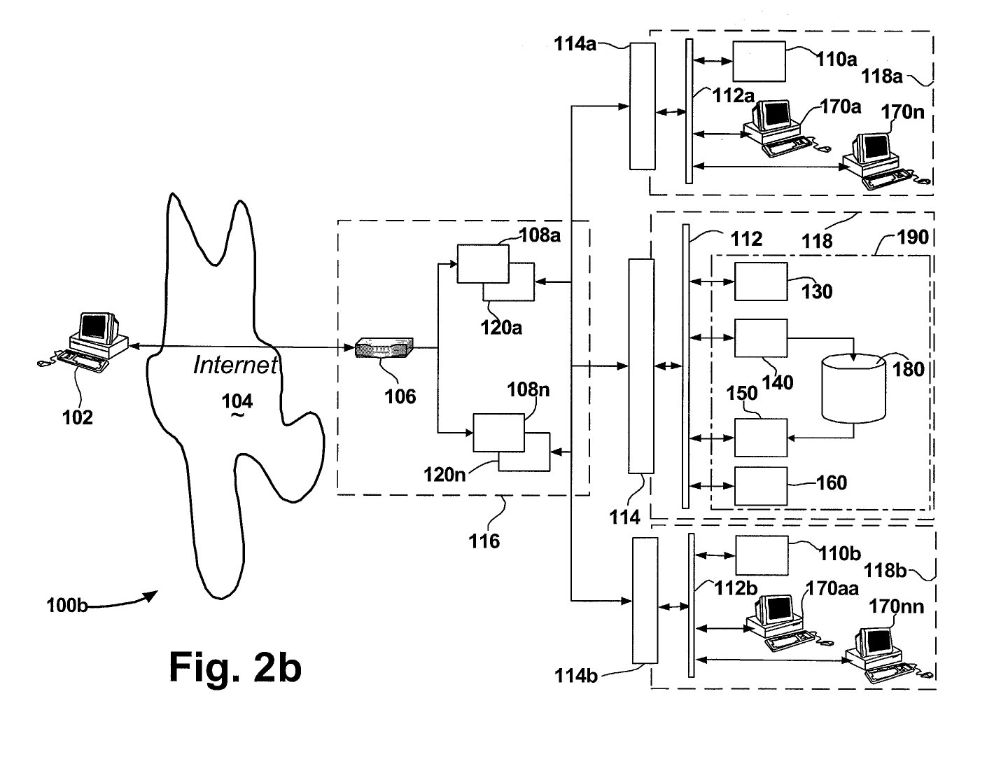

Turning now to FIG. 2, a top-level architectural overview of an exemplary collaboration and web session capture system 100 of the present invention, which is capable of performing the web session transaction and web session collaboration depicted in FIGS. 1a through 1i, is illustrated. The system 100 is implemented within and includes components of a conventional computer network in which an end user accesses a web site over the Internet. The elements of the conventional computer network include the computer 102 of the end user, a communications medium, such as the Internet 104, a router 106, one or more web servers 108, one or more application servers 110, a network communications bus 112, and a firewall 114. Preferably, as with the computer 102 of the customer 50 from FIGS. 1a through 1i, the end user's computer 102 has installed thereon web browser software. It is common for a plurality of web servers 108 (e.g., “web server farm” or “server arrangement”) to be used (as opposed to just one web server 108) for improved scalability and availability of access to the web servers 108. Communications between the end user's computer 102 and the web servers 108 are preferably routed to and from the appropriate web servers 108ato 108n by means of router 106 in conventional manner. The communications medium 104 is presumed to be insecure; thus, firewall 114 is used to isolate and separate the internal network 118 of the entity from the publicly-accessible portion (DMZ) 116 of the web host provider's network.

As will be described herein, the purpose of system 100 is to capture requests received by and corresponding responses sent by the web servers 108 for subsequent use by the collaboration server arrangement 190, including re-creation and replay of a web session of the end user on computers 170 for collaboration purposes. As will become apparent hereinafter, of significant interest in the present invention are those “primary requests” that ask (via an HTTP GET method) for a particular web page. The response to such a primary request typically contains “text/html” (or comparable) that instructs the browser on computer 102 how to display the web page. The response body typically also includes one or more identifiers, pointers, or URLs that instruct the browser on computer 102 to make further or “subordinate requests” to obtain images and other resources on web server 108 (or application server 110) that are necessary to complete the web page. The browser on computer 102 generates these secondary or subordinate requests to obtain each of these additional resources.

Also of interest in the present invention are those requests that submit (via an HTTP POST method) information input by the end user into a form on the web page. As should be appreciated, a “blank” form is typically provided to the end user in response to a previous request. Further, the response to submission of a filled-in form is typically a “thank you, ” “request for confirmation, ” or “error” web page. Thus, a “filled-in” form does not typically appear within the content portion of a request or a response but in the combination of the response content containing the form and the request content containing the information filled-in by the end user into the form fields. This process was briefly described in association with FIGS. 1a through 1i and will be discussed in greater detail hereinafter.

Still referring to FIG. 2, though the various components of the system 100 are illustrated and described separately, it should be understood that all or any combination of these components are capable of being installed on or part of a single server, computer, computer system, or server arrangement. Conversely, even though all of the components of the system 100 are illustrated as being part of the same network, this is not necessary either. The network itself may either be the Internet, an intranet, or other dedicated network. Each component comprises software, hardware, or a combination of both. Preferably, the components of the system 100 include one or more capture components 120 and a collaboration server arrangement 190. The collaboration server arrangement 190 preferably includes a collection component 130, a database manager 140, a collaboration services component 150, a presentation component 160, and database storage 180. The system 100 also preferably includes one or more computers 170 of one or more CSRs. The computers 170 may, but do not have to be, part of the collaboration server arrangement 190. As shown in FIG. 2, the computers 170 are not part of the collaboration server arrangement 190. Each capture component 120 generally operates within the publicly-accessible portion 116 of the Web host provider's network. In contrast, the remaining components 130, 140, 150, 160, and 180 of the collaboration server arrangement 190 generally operate within the internal portion 118 of the web host provider's network or entity's network protected by firewall 114. As shown in arrangement of FIG. 2, the computers 170 also operate within the internal portion 118 of the web host provider's network or entity's network protected by firewall 114. Communication between the various components 130, 140, 150, 160, 170 and 180 is facilitated by network communication bus 112, as shown. Communication between each capture component 120 and the collection component 130 is facilitated by a data transfer mechanism (not shown).

Each capture component 120 preferably comprises a plug-in installed into a web server 108. For reasons that will become apparent, it is desirable for the system 100 (and each clock used to obtain or generate time and date stamps) to maintain a common (i.e., synchronized) notion of time. Although not shown, it is preferable that each capture component 120 include its own clock or other means of associating a time and date stamp (hereinafter “timestamp”) with each request and response it captures, as discussed herein.

In a preferred embodiment, the collection component 130 and database manager 140 are part of the same physical component. Likewise, in a preferred embodiment, the collaboration services component 150 and the presentation component 160 are part of the same physical component.

Turning briefly to FIG. 2a, another exemplary arrangement 100a of the system of the present invention is illustrated. In system 100a, components 120, 130, 140, 150, 160, 170 and 180 are used to support a plurality of application servers 110a, 110b, each associated with a different entity. As shown, each application server 110a, 110b (and, correspondingly, each entity) communicates with the computer 102 of an end user by means of a web server or web server farm 108ato 108n and 108aa to 108nn, respectively. As shown in FIG. 2a, the computers 170 are part of the collaboration server arrangement 190.

Turning briefly to FIG. 2b, another exemplary arrangement 110b of the system of the present invention is illustrated. In system 100b, components 120, 130, 140, 150, 160, and 180 are used to support a plurality of application servers 110a, 110b, each associated with a different entity. As shown, both application servers 110a, 110b (and, correspondingly, both entities) share the same web server or web server farm 108ato 108n for communication with computer 102 of the end user. In contrast with FIG. 2a, however, each entity has its own (and, in this case, “inhouse”) customer service department represented by the CSR's computers 170a to 170n and 170aa to 170nn, respectively. Similar to FIG. 2, the computers 170 in FIG. 2b are not part of the collaboration server arrangement 190.

Obviously, many other physical arrangements (not shown) for either or both the convention computer network and for the collaboration and web session capture systems are possible within the scope of the present invention. Regardless of the physical arrangement, further references to any system 100, 100a, 100b and any other physical arrangement of components not shown, will be referred to hereinafter simply as system 100.

System Functional Overview

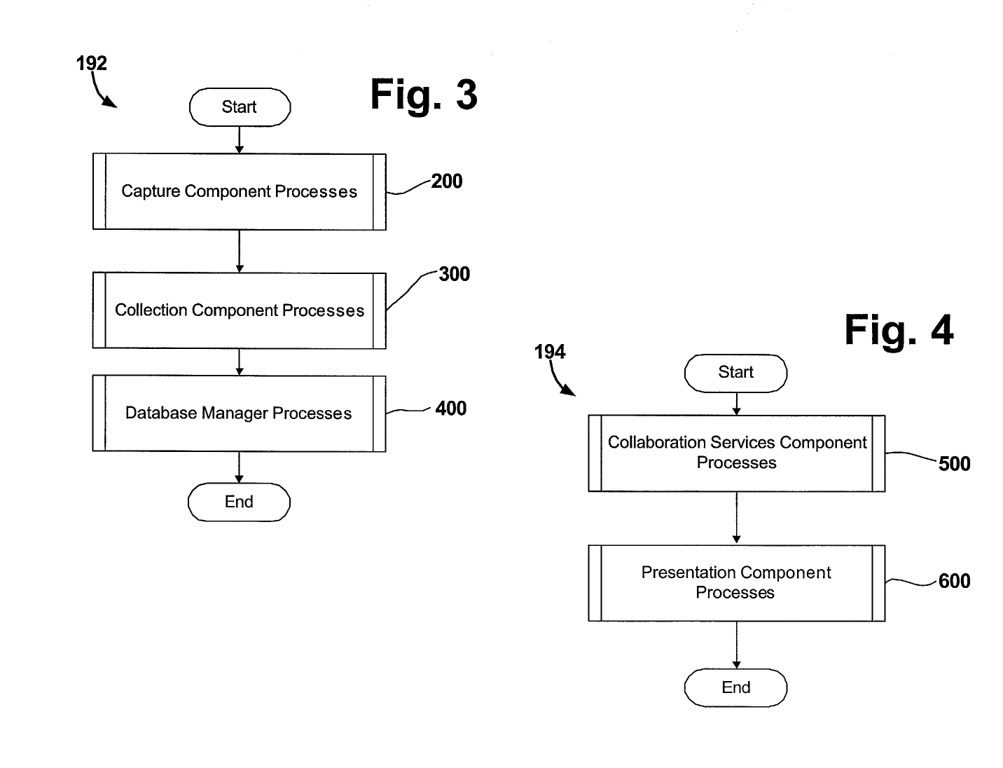

Turning now to FIG. 3, an overview of the sequence of processes performed preferably by the components 120, 130, 140, and 180 of the system 100 is illustrated. Generally, these processes can be described as the front end processes 192 of the system 100. The front end processes 192 continually run on the collaboration server arrangement 190 and on the web servers 108 for web sites and enterprise applications with which the system 100 has been associated or installed. The front end processes 192 comprise the capture component processes 200, followed by the collection component processes 300, and then the database manager processes 400. Functionally, the result of the front end processes 192 is that a web session (or predetermined number of web pages of a web session) of an end user of an entity's application is captured and stored in a retrievable manner in database storage 180.

Turning now to FIG. 4, an overview of the sequence of processes performed preferably by the components 150, 160, and 180 of the system 100 is illustrated. These processes interact closely with the browsers running on computers 170, as will be described hereinafter. Generally, these processes can be described as the back end processes 194 of the system 100. Preferably, the back end processes 194 are only performed when necessary (e.g., when a CSR receives a “help” request from the end user and needs to review a re-creation of the particular end user's web session or when the CSR wants to view a form, as filled-in by the end user). Thus, the back end processes 194 are typically initiated by a CSR (or by the CSR interface running on computer 170, as described herein), when the CSR needs to review a re-creation of the web session of a particular end user. The functional result of the back end processes 194 is that the CSR is able to view any web session of an identified end user (or identified enterprise application session) offline or in near-real-time, if necessary. Further, for those web pages representing the submission of HTML forms (using an HTTP “POST” method), the system 100 is able to display to the CSR a “filled-in” representation of the form at the time it was submitted by the end user. A more detailed explanation of these various processes is described herein.

Front End Processes

a. Capture Component Processes

In summary, each capture component 120 is responsible for capturing each request and associated response (“request/response pair” or “request and corresponding response” or “request and associated response”) and, after performing appropriate pre-processing, forwarding the same to the collection component 130 for further processing.

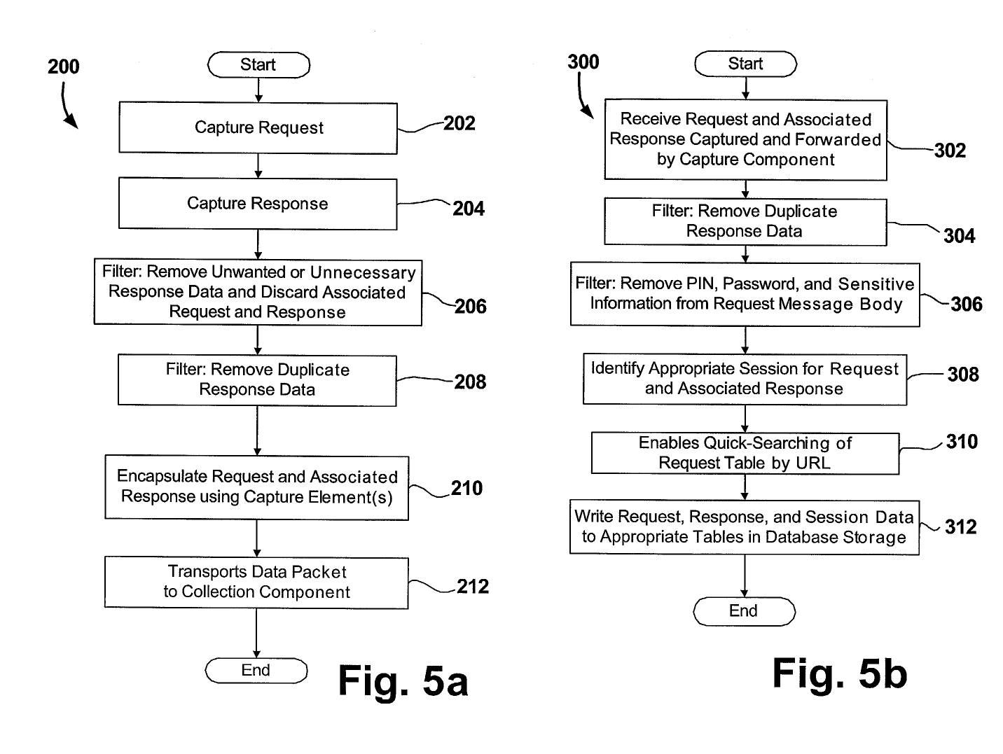

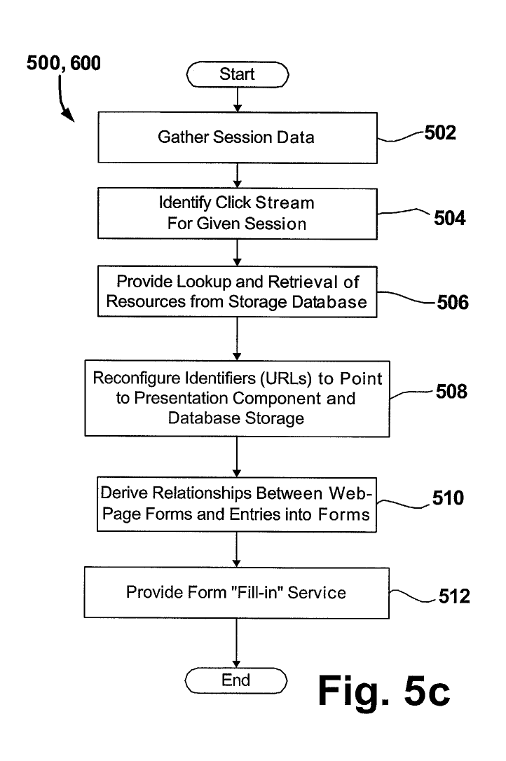

As shown in FIG. 5a and with reference back to the components identified in FIG. 2, each capture component 120 performs the following primary functions: it captures (Step 202) each request received from a browser having an appropriate browser identification; it captures (Step 204) each associated response; it filters (Step 206) each response to eliminate unwanted or unnecessary data content types and discards both the request and response associated therewith; it filters (Step 208) each response to remove duplicate responses that have already been sent to the applicable collection component 130; it encapsulates (Step 210) each request and response along with additional information using one or more “capture elements;” and transports (Step 212) such encapsulated information within a data packet to the collection component 130.

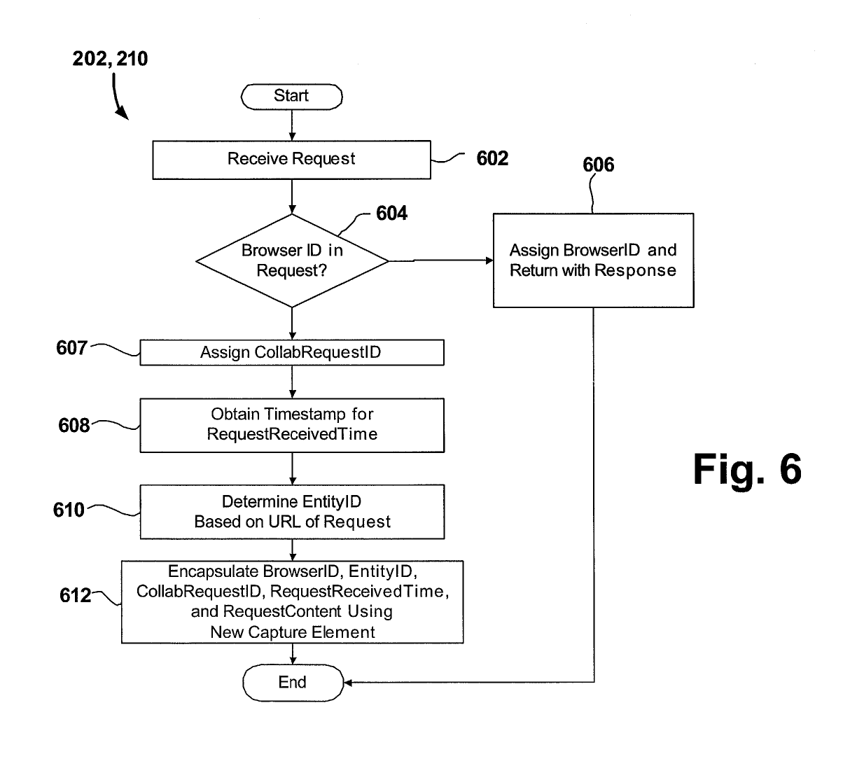

The processes of Steps 202 and 210 will now be described in greater detail with reference to FIG. 6. When a request is first received (Step 602) at the capture component 120, the capture component 120 first determines (Step 604) whether the browser from which the request came has a browser identification (BrowserID). If not, then the capture component 120 sends (Step 606) a newly assigned BrowserID to the end user computer 102 (preferably as a “cookie”) when the corresponding response from the web server 108 is returned to computer 102. If the request has an associated BrowserID, then the capture component 120 first assigns (Step 607) a unique and arbitrary identifier to the request (CollabRequestID) and then obtains (Step 608) a timestamp (RequestReceivedTime) corresponding with the date and time the request was received by the capture component 120. The timestamp is preferably generated using a clock within the capture component 120 or web server 108. As stated previously, it is highly desirable that all clocks within the system 100 be substantially synchronized with each other so that the system 100 as a whole maintains a common notion of time. Next, the capture component 120 determines (Step 610) the identification of the entity receiving the request (EntityID) based on the URL of the requested resource. Preferably, the capture component 120 maintains a list of URLs and associated entity identifications (EntityIDs). Obviously, if the capture component 120 only captures requests for a single entity, then the same entity identification (EntityID) is made for every request. Finally, the capture component 120 encapsulates (Step 612) the browser identification (BrowserID), entity identification (EntityID), request identifier (CollabRequestID), request timestamp (RequestReceivedTime), and content of the request (RequestContent) using a new capture element (“capture elements” will be discussed in greater detail momentarily).

Turning back to FIG. 5a, each corresponding response to a particular request is also captured (Step 204) by the capture component 120. It should be understood by one skilled in the art that the relationship between a request and its corresponding or associated response is implicit in the flow control maintained by the web servers 108. In essence, the capture component 120 relies upon this relationship provided by the web servers 108 to maintain the relationship between requests and responses it captures. Before the response is encapsulated (Step 210) using a capture element, the response is subject to two layers of filtering (Steps 206 and 208). The first layer of filtering performed by the capture component 120 is for the purpose of preventing unwanted or unnecessary responses (and the corresponding requests) from being sent to the collection component 130. For example, a response may comprise audio, video, multi-media, or other content-type files that are not needed or desired by the collaboration server arrangement 190 or CSR. In such a situation, both the request and response are discarded. The list of content types for responses that are unwanted or unnecessary in any particular application or system is easily configurable, as desired by the entity. The second layer of filtering is performed to prevent sending duplicate responses to a collection component 130. For example, a typical application, including associated web pages, consists of a large number of static content, such as jpeg, tiff, and .gif images, which are sent to the end user. These images have the potential to be sent to many end users during the execution lifetime of a particular web server 108 (i.e., between the time the capture component 120 is initialized on a particular web server 108 until the capture component 120 or web server 108 shuts down or unexpectedly terminates); however, since such images do not change (or change only infrequently) it is unnecessary for duplicate copies of such static content to be transmitted over and over by a particular capture component 120 to a collection component 130. The second layer of filtering ensures that the capture component 120 only sends a single copy of a particular response to a particular collection component 130. Although a particular capture component (for example, 120a) may send a response identical to one that it generated in a previous lifetime or one sent by a different capture component (for example, 120b-120n), the number of duplicates shipped across the typical network connection between capture components 120 and a particular collection component 130 is greatly reduced.

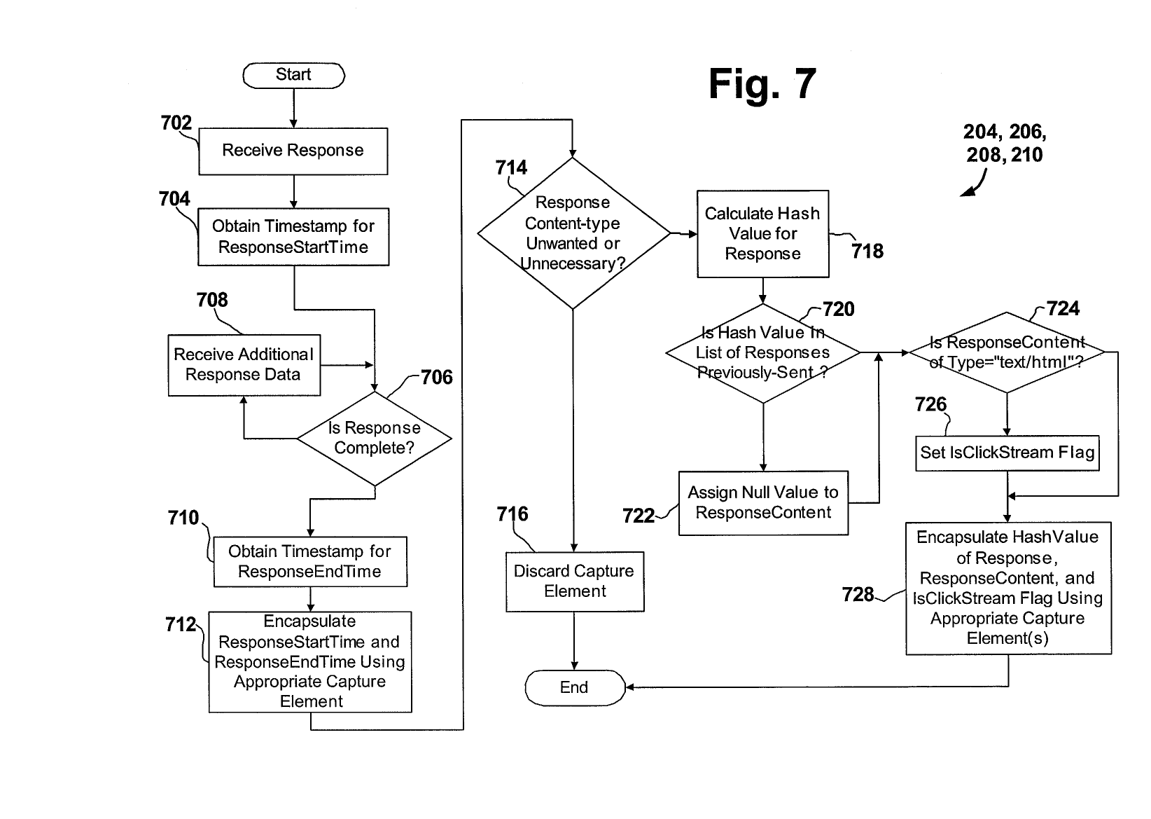

Turning now to FIG. 7, a more detailed flow-chart of the processes performed by Steps 204, 206, 208, and 210 from FIG. 5a is illustrated. When a response or portion of a response is first received (Step 702) by a particular capture component 120, the capture component 120 obtains (Step 704) a timestamp for the start of the response (ResponseStartTime). Next, the capture component 120 determines (Step 706) whether the response is complete. If not, then the capture component 120 receives additional response data (Step 708) and loops between Steps 706 and 708 until the response is complete. Once the response is complete, the capture component 120 obtains (Step 710) a timestamp for the end of the response (ResponseEndTime). The capture component 120 then encapsulates (Step 712) the start and end timestamps of the response using the same capture element used for the associated request (CollabRequestID and RequestContent).

Next, the capture component 120 performs the first layer of filtering by first determining (Step 714) whether the response is of a content-type that has been identified as unwanted or unnecessary for the CSR. Such a determination can be made by examining the header in the response that contains the content-type description. If the response content type matches any of the content types that have been previously identified as being unwanted or unnecessary for the collaboration server arrangement 190 or CSR, then the capture component 120 discards (Step 716) not only the response but also the entire capture element associated with the response since neither the request nor the response are necessary for subsequent use by the system 100, such as replay of the web session. If the determination in Step 714 is negative, then the capture component 120 proceeds to the second layer of filtering.

The second layer of filtering begins when the capture component 120 calculates (Step 718) a hash value (in known manner) for the response. It should be understood that performing a hash function on any particular response generates a unique hash value for that response. Any modification to one bit of information in a response generates a different hash value. Preferably, the hash value represents a 128-bit message digest generated using the MD-5, SHA-1, or comparable hash function algorithm. As will be appreciated by one skilled in the art, the likelihood that two different responses generate the same 128-bit hash value is extremely unlikely. Conversely, two identical responses should generate the same hash value; thus, filtering, as discussed herein, is possible merely by comparing hash values of responses. Regardless of which hash function is used, however, the system 100 must consistently use the same hash function throughout for consistency and reliability, since subsequent hash values are used for such filtering comparisons. Preferably, the hash value is calculated for the response body; however, it is possible for the hash value to be calculated for the entire response as long as the status line and any headers that will vary every time the same response is generated by a web server 108 are consistently removed or stripped from the response for purposes of calculating the hash value in Step 718.

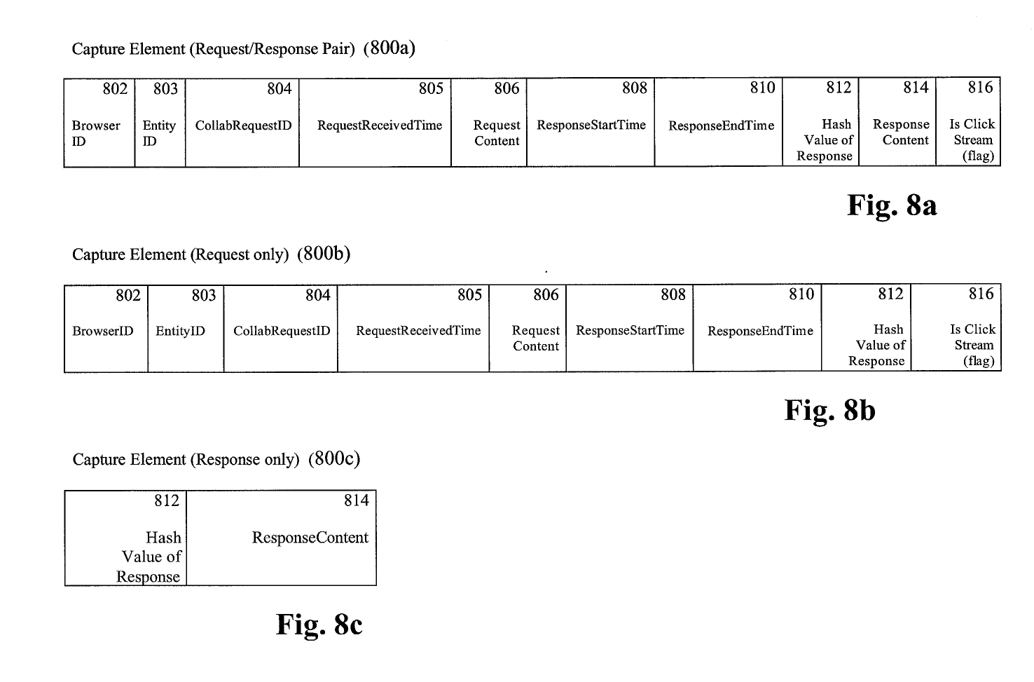

Once the hash value for the response has been calculated, the capture component 120 then compares (Step 720) this calculated hash value with a list of hash values corresponding to responses previously sent to the particular collection component 130 by this capture component 120. If the hash value matches a hash value already maintained in the above-referenced list, then the capture component 120 assigns (Step 722) a null value to the contents of the response (ResponseContent). If the determination in Step 720 is negative or after Step 722 has been performed, the capture component 120 next determines (Step 724) whether the response is a “text/htnml” content type. If so, the capture component 120 sets (Step 726) an IsClickStream flag. Use of the IsClickStream flag is discussed in greater detail herein in association with the processes performed by the collaboration services component 150. Also, as used herein, it should be understood that when a flag is “set, ” its value is made one, yes, on, or any comparable value. In contrast, when a flag “reset, ” its value is made zero, no, off, or any comparable value. After the IsClickStream flag is set in Step 726 or after the determination in Step 724 is negative, the capture component 120 encapsulates (Step 728) the hash value of the response, the content of the response (ResponseContent), and the value of the IsClickStream flag using the appropriate capture element(s). In an alternative preferred embodiment, if requests and responses are encapsulated using separate capture elements (e.g., capture elements 800b, 800c, as discussed immediately hereinafter in association with FIGS. 8b, 8c), then rather than assigning a null value to the ResponseContent, Step 722 merely discards the capture element for the response only. If proceeding from this alternative Step 722, then Step 728 merely encapsulates the hash value of the response and the IsClickStream flag using the capture element associated with the request only. If proceeding from a negative determination in Step 720, the Step 728 remains the same in this alternative preferred embodiment.

Turning now to FIGS. 8athrough 8c, various data structures for the capture element are illustrated. As should be appreciated from the previous discussion, the capture element 800a is merely an abstraction of an HTTP request and associated response. The capture element 800a for the request and associated response encapsulates the following information: the browser identification for the end user's computer (BrowserID) 802, the identification of the entity (EntityID) 803, the request identifier (CollabRequestID) 804, the request timestamp (RequestReceivedTime) 805, the content of the request (RequestContent) 806, the response start timestamp (ResponseStartTime) 808, the response end timestamp (ResponseEndTime) 810, the hash value of the response 812 (which will ultimately become the CollabResponseID, as described in association the collection component processes 300 hereinafter), the contents of the response (ResponseContent) 814, and the IsClickStream flag 816. In an alternative preferred embodiment, illustrated by both FIGS. 8band 8c, one capture element 800b corresponds with a request and another capture element 800c corresponds with a response. The information encapsulated by the separate capture elements 800b and 800c is also illustrated in FIGS. 8band 8c, respectively, with the same information identifiers used in FIG. 8a. If the capture component 120 encapsulates each request and corresponding response using separate capture elements 800b, 800c, it is necessary for the request and response to maintain their association or link with each other. For this reason, the capture elements 800b, 800c both encapsulate the hash value of the response 812, so that the collection component 130 is able to maintain the association or link between the information encapsulated by the two separate capture elements 800b, 800c. It should also be noted that, because of the use of the hash value of the response 812 to tie these two separate capture elements 800b, 800c together, it is unnecessary for the capture element 800c to encapsulate the BrowserID 802 and EntityID 803, since they are already encapsulated in capture element 800b. For convenience and to keep the values from being discarded when the capture element 800c for a response only is discarded (as described above) as being a “duplicate” response, it is also preferable for the capture element 800b to encapsulate the ResponseStartTime 808 and ResponseEndTime 810 values.

Referring back to FIGS. 2 and 5a, in accordance with Step 212, once the request and response pair are encapsulated using the capture element or capture elements, as the case may be, the capture component 120 queues each capture element for transmission of the encapsulated information to the appropriate collection component 130 using the transport mechanism. The transport mechanism preferably packages the encapsulated information within a data packet that contains a header (which identifies the type of information being transmitted), the encapsulated information, and an optional checksum value (which enables the collection component 130 to verify that no information was lost in transmission). For security purposes, it may be desirable to encrypt the data packet prior to transmission. The transport mechanism preferably is any one of the following: shared memory, network-based mailboxes, Unix-style pipes, flat files, reliable queuing facility, an IPC-type mechanism, or any comparable device or means. As is conventional, the transport mechanism is logically divided into two layers: an upper layer interface that enables data packet creation and identification and a lower layer that provides an interface to the actual transport structure that is used to move the data packet from the capture component 120 to the collection component 130.

For the system 100 to remain reliable, it is necessary for the transport mechanism to be reliable, which means that once a data packet is handed-off to the transport mechanism by each capture component 120, its existence and content are guaranteed to remain intact, regardless of the state of the system 100, until the data packet is removed from the transport mechanism by the collection component 130. The transport mechanism maintains and uses several data structures to manage data packets as they are being created along with maintaining the state of the transfer of data packets as they are being transmitted from each capture component 120 to the collection component 130. After the data packet has been transferred to the collection component 130 by the lower layer of the transport mechanism, the data packet is decrypted, if necessary, and unpacked by the collection component 130 to reform the encapsulated information.

Although not shown in any of the network configurations in FIGS. 2, 2a, or 2b, if multiple entities or enterprise applications, each having its own collection component 130, are served by a particular web server 108 or web server farm, it may also be necessary for each capture component 120 (and/or transport mechanism) to identify which particular collection component 130 should receive a particular data packet.

b. Collection Component Processes

In summary, the collection component 130 is responsible for receiving, decrypting (if necessary), and unpacking data packets comprising requests and/or responses received from each capture component 120 and, after performing additional processing, writing request data and response data to appropriate request tables and response tables created and maintained by the database manager 140 and stored within database storage 180.

Even more importantly, the collection component 130 is responsible for associating a plurality of separate requests and responses into identifiable sessions. For example, the collection component 130 uses the browser identification (BrowserID), entity identification (EntityID), and request received timestamps (RequestReceivedTime) supplied by each capture component 120, together with any additional information (such as user identification (UserID) or application session identification (ApplSessionID)) provided by the enterprise application in response to appropriate queries from the collection component 130, to identify which requests and responses belong together in a particular session. These identifiable sessions are later used by the collaboration services component 150 and the presentation component 160 to re-create and display coherent click-streams of the end user to the CSR on computer 170.

As shown in FIG. 5b and still with reference back to the components of FIG. 2, the collection component 130 performs the following primary functions: it receives (Step 302) requests and responses captured and forwarded by each capture component 120; it filters (Step 304) duplicate responses received from different capture components 120; it removes (Step 306) sensitive data, such as PINs and passwords, from each request message body; it organizes (Step 308) requests and responses into identifiable sessions; it enables (Step 310) quick-searching of the request tables by URL; it writes (Step 312) request, response, and session data to appropriate request, response, and session tables maintained by the database manager 140 and stored within database storage 180.

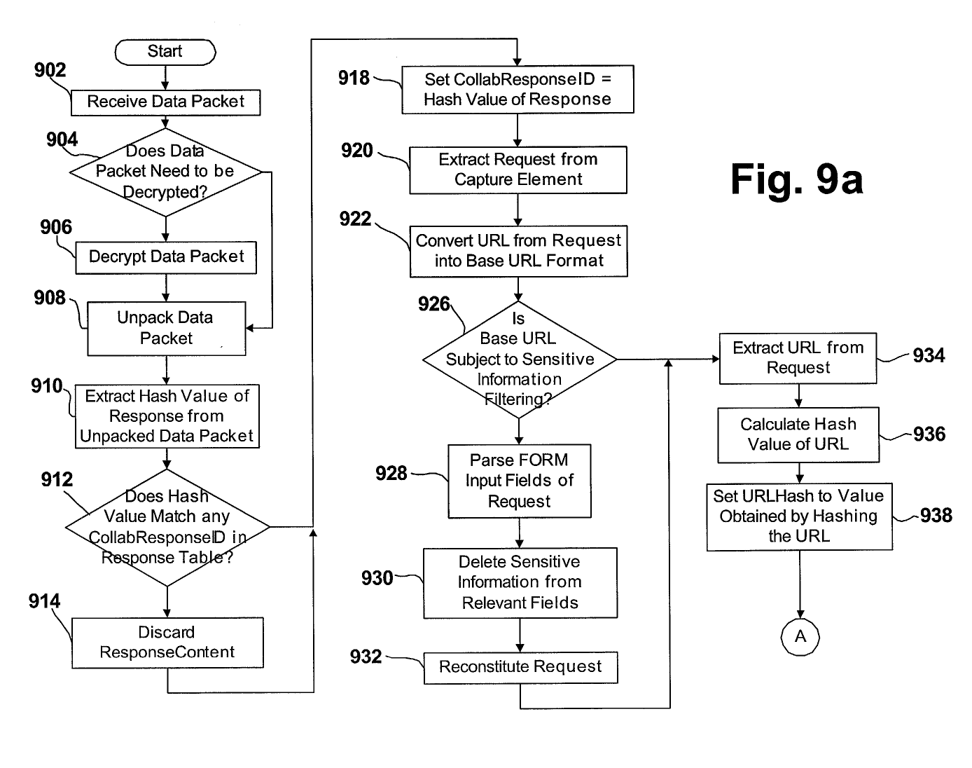

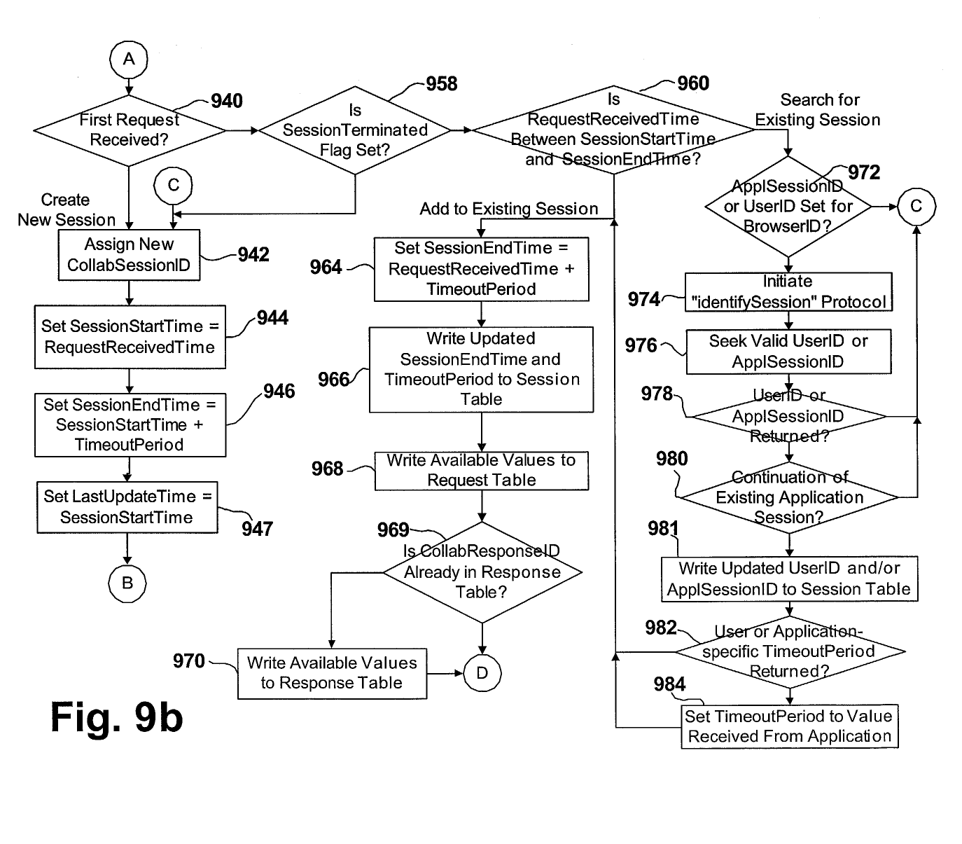

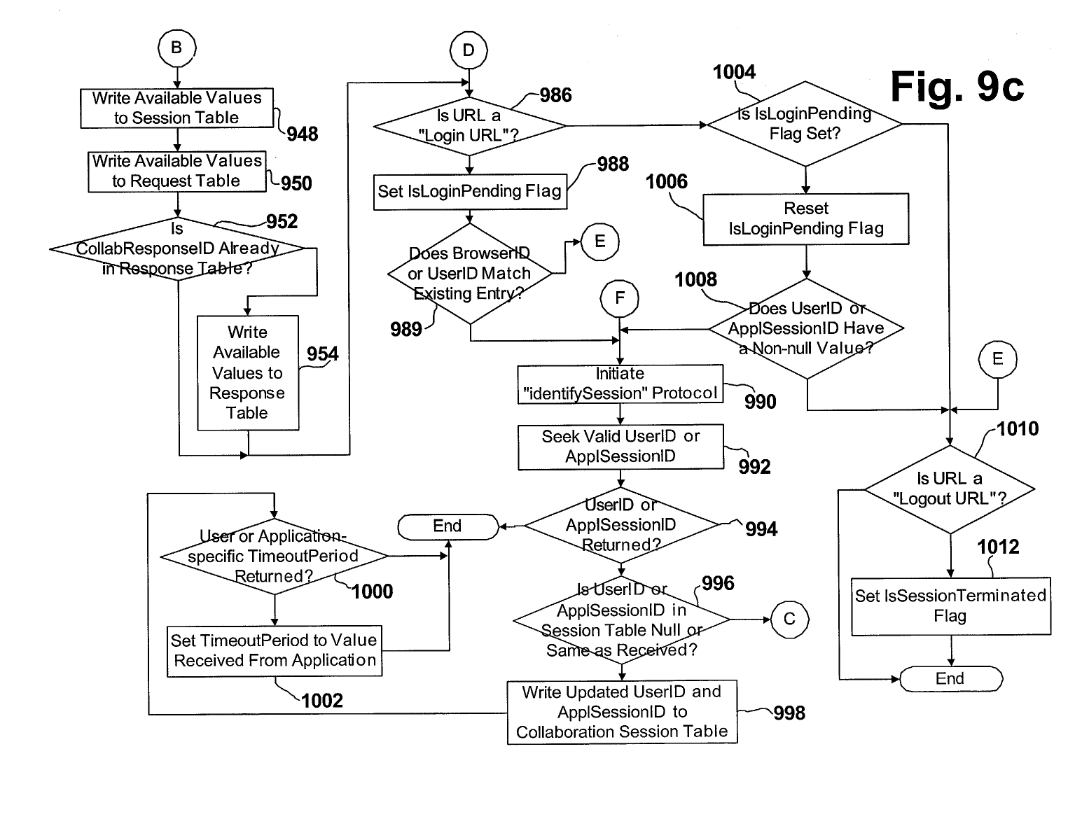

Turning now to FIGS. 9a-9c (referred to hereinafter simply as FIG. 9), a more detailed flow-chart of the processes performed by the collection component 130 is illustrated. “Jumps” between FIGS. 9a, 9b, and 9c (and in some cases between points within the same figure) are shown by a letter in a circle. As stated previously, captured requests and responses are sent from each capture component 120 to the collection component 130 within data packets by means of a queued transport mechanism. Thus, the collection component 130 first receives (Step 902) such data packets. A determination (Step 904) is made as to whether the data packet needs to be decrypted and, if so, it is decrypted (Step 906). Otherwise, the collection component 130 next unpacks (Step 908) the encapsulated information from the data packet.

Like each capture component 120, the collection component 130 performs two additional layers of filtering (as shown in FIG. 5b by Steps 304 and 306). With regard to Step 304, since a collection component 130 may receive requests and responses from more than one capture component 120, it is preferable for the collection component 130 to perform a third layer of filtering to remove duplicate responses received from different capture components 120. This third layer of filtering is very similar to the second layer of filtering performed individually by each capture component 120. In particular, returning now to FIG. 9, the collection component 130 first extracts (Step 910) the hash value of the response from the capture element. If this hash value matches (Step 912) any hash value for a response previously received by the collection component 130 (such hash values being stored as CollabResponseID values maintained in the response table in database storage 180), then the collection component 130 assumes that this response is merely a duplicate and discards (Step 914) the contents of the response (ResponseContent) so that it is not stored again in the database storage 180. Once the contents of the response have been discarded (in Step 914) or if the hash value of the response is not a match (in Step 912), then the collection component 130 next sets (Step 918) the value for the CollabResponseID for this response to the hash value of the response obtained from the capture element.

The collection component 130 also performs (as shown in FIG. 5b, Step 308) a fourth layer of filtering to remove passwords, PINs, or other sensitive information contained within requests. Such information typically appears in a request having an HTTP POST method (e.g., a log-in form, a create account form). The collection component 130 filters sensitive fields from the HTTP form inputs based on a configuration file associated with each particular enterprise application or web site of the entity. This configuration file typically is unique to each application supported by the system 100 and possibly unique to each form used within a particular application since the location of sensitive information will potentially vary with each form used by the application or web site. The configuration file identifies which data fields of the form submittal are likely to include such sensitive information. The preparation of such a configuration file is within the scope of those skilled in the art. Briefly, however, the configuration file for a “form” identifies which URLs have requests subject to filtering. Each URL identified in the configuration file indicates a “base URL;” that is, a URL after any ‘?’ and following parameters have been stripped from the end.

Referring back to FIG. 9, the process of filtering such sensitive information starts when the collection component 130 extracts (Step 920) a request from the capture element. The collection component 130 then converts (Step 922) the URL from the request into a base URL, as described above. The collection component 130 then determines (Step 926) whether the base URL from the request matches any base URL from the applicable configuration file. If so, then the collection component 130 parses (Step 928) all form inputs to identify their name/value pairs (i.e., whether the inputs appear in the “content” portion of the request, as is typically done with an HTTP “POST” method, or as arguments following a ‘?’ character in the URL, as is usual for an HTTP “GET” method). Next, any values from any field name identified in the configuration file as containing sensitive information are deleted (Step 930). Following removal of any configured input fields, the request is reconstituted (Step 932) as if the deleted values had never been present.

Following these additional filtering processes and still referring to FIG. 9, the collection component 130 then extracts (Step 934) the URL from the request. More specifically, the URL for this purpose is taken verbatim from the URI field of the request. (See RFC 2616—The HyperText Transfer Protocol, which is incorporated herein by reference.) The entire URI field is used since that is the form used by the browser in satisfying IMAGE (<IMG>) html tag specifications. The collection component 130 calculates (Step 936) a fixed length hash value (preferably 48 characters) for this URL (preferably by passing the URL through the same hash function used to generate the hash value of the response in each capture component 120). The collection component 130 then sets (Step 938) the value of a URLHash variable to the hash value of the URL just calculated. As will become apparent later, this URLHash is included in the request table and may be used by the collaboration services component 150 to support efficient searching of the request table by URL.

As stated previously with regard to Step 308 of FIG. 5a, the collection component 130 is responsible for associating related requests and responses into identifiable collaboration “sessions.” As previously defined, a collaboration “session” within the scope of the present invention typically means a sequential set of URLs serviced by a single entity and viewed by a single end user from a single browser. A complete collaboration session is typically generated within a relatively short period of time, though there is no strict limit on the duration of a complete collaboration session. In order to distinguish among the many different browsers that may be in contact with the application server 110 at any given time, the system 100 preferably uses a browser identification (BrowserID). The browser identification, which is preferably an HTTP cookie, is fabricated and assigned to a browser by each capture component 120, as described previously.

A collaboration “session” identified by the collection component 130 is typically closely associated with an affiliated application's “session, ” although the two need not be identical. As will be described herein, the collection component 130 attempts to use an application's notion of “session” (using variable ApplSessionID, as discussed herein) to define a collaboration “session” within the system 100 as well. That is, if the enterprise application processes requests on behalf of a given user or account, the requests and responses corresponding with that application session or stream of web pages also are identified by the collection component 130 and associated in database storage 180 with such user or account.

In many cases, however, the affiliated enterprise application may be executing on an application server 110 that is part of a different computer system (or systems) than the one on which the collection component 130 is operating, so requesting user identification (UserID) or application session information (ApplSessionID) from the application for each request or response typically presents an unacceptable performance bottleneck. It is also desirable for the system 100 to track web pages visited by an end user prior to the formal establishment of an application session (i.e., where no ApplSessionID has been identified or created by the affiliated application), or in some cases, where no application session is established at all. Finally, there may be more than one application session identification (ApplSessionID) available for a given end user, for example, if the end user is accessing multiple enterprise applications of one or more application servers 110 of an entity. The strategy described hereinafter maintains the association of a stream of web pages with a particular end user where possible, while only asking the affiliated enterprise application to provide user identification (UserID) or application session identification (ApplSessionID) at a few well-defined points during the web session.

Turning now to FIG. 9b, the collection component 130 next determines (Step 940) whether the request received is the first such request from a given browser (based on BrowserID) targeted to a given entity (based on EntityID) for which there are no currently-open or active sessions. If it is the first such request received, then a new session is created and a new, unique collaboration session identifier (CollabSessionID) is assigned (Step 942) to the request. Next, the corresponding session start time (SessionStartTime) is set (Step 944) to the value of the time at which the request was received (i.e., RequestReceivedTime). The expiration time for the collaboration session (SessionEndTime) is initially set (Step 946) to a value equal to the session start time (SessionStartTime) plus a predetermined timeout period (TimeoutPeriod), which is preferably set at a default value by the collection component 130 unless a user-specific value from the affiliated enterprise application is available, as discussed herein in association with Steps 982, 1000. The latest time at which there is any activity in the session (LastUpdateTime) is initially set (Step 947) to the session start time (SessionStartTime) as well. Other values associated with a collaboration session, such as an application session identifier (ApplSessionID) and an end user identifier (UserID) may not be available to the collection component 130 initially and no further attempt is made to identify either of these values at this time.

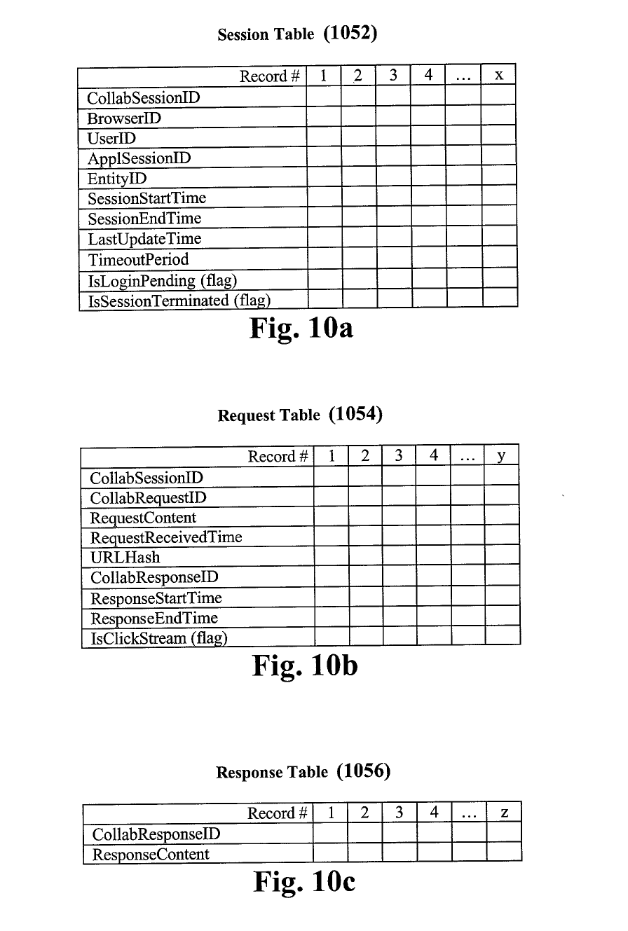

Next, the collection component 130 writes (Step 948) into an available database record of the session table (which is preferably created and maintained in the database storage 180 by the database manager 140) all available values for the CollabSessionID, BrowserID, EntityID, UserID, ApplSessionID, SessionStartTime, SessionEndTime, LastUpdateTime, and TimeoutPeriod. The TimeoutPeriod is initially set to its default value. Any other values not currently available are set to null values. In addition, several flags, including IsLoginPending and IsSessionTerminated, are reset. As mentioned previously, when a flag is “reset, ” its value is made zero, no, off, or any comparable value. In contrast, when a flag is “set, ” its value is made one, yes, on, or any comparable value. An example of the session table 1052 is illustrated in FIG. 10a. Records in session table 1052 range from record 1 to record x.

Next, the collection component 130 writes (Step 950) into an available database record of the request table (which is preferably created and maintained in the database storage 180 by the database manager 140), the following values, if available: CollabSessionID, CollabRequestID, RequestContent, RequestReceivedTime, URLHash, CollabResponseID, ResponseStartTime, ResponseEndTime, and IsClickStream (flag). Since one or more different requests may be associated with an identical response content (which is maintained only once in the database storage 180), it is necessary for the request table to include the relevant response information, such as CollabResponseID, ResponseStartTime, and ResponseEndTime, so that proper associations may be maintained within the database storage 180. Since the request table includes information for both a request and a response, this table may more accurately be described as a “transaction table.” Any values not available are set to null values and the flag value is reset if not already set by the capture component 120 (as discussed previously). An example of the request (or transaction) table 1054 is illustrated in FIG. 10b. Records in request table 1054 range from record 1 to record y.

Next, the collection component 130 determines (Step 952) whether the CollabResponseID is already in the response table (which was previously discussed with reference to Step 912). If the determination in Step 952 is negative, then the collection component 130 writes (Step 954) into an available database record of the response table (which is preferably created and maintained in the database storage 180 by the database manager 140) the following values: CollabResponseID and ResponseContent. If there is no information available regarding the ResponseContent, it is set to a null value. An example of the response table 1056 is illustrated in FIG. 10c. Records in response table 1056 range from record 1 to record z.

Returning to FIG. 9, if the determination in Step 952 is positive or after Step 954 is performed, the collection component 130 proceeds to Step 986, which will be discussed presently.

If the determination in Step 940 is negative (i.e., the request is not the first one received for this BrowserID and EntityID or there is a currently-open session associated with this BrowserID and EntityID), then the collection component 130 next determines (Step 958) whether the IsSessionTerminated flag has been set for all available (or the currently-open) sessions associated with this BrowserID and EntityID. As will become apparent hereinafter, when the IsSessionTerminated flag is set (e.g., in association with Step 1012), it is an indication that the end user has “logged-out, ” timed out, or otherwise become unidentified within the relevant, affiliated application and, thus, that the request under consideration should be considered part of a “new collaboration session” notwithstanding the determination in Step 940. Thus, if the determination in Step 958 is positive, the collection component 130 identifies the current request as belonging to a new session and, therefore, proceeds to Step 942. If the determination is step 958 is negative, the collection component 130 continues on to Step 960.

The collection component 130 now attempts to add the request under consideration to an existing session. In Step 960, the collection component 130 determines whether the request was received between the session start time and session end time of any identified session for this particular browser and entity (i.e., whether the RequestReceivedTime is after any SessionStartTime but before any corresponding SessionEndTime for this particular BrowserID and EntityID). If so, then the collection component 130 identifies the request under consideration as belonging to an existing session and proceeds to Step 964. In Step 964, the collection component 130 updates the session expiration time (SessionEndTime) by adding the TimeoutPeriod to the current RequestReceivedTime. Next, the collection component 130 writes (Step 966) the updated value for the SessionEndTime and TimeoutPeriod (if updated) to the appropriate database record in the session table 1052 (i.e., the database record having the relevant CollabSessionID). Next, the collection component 130 writes (Step 968) into an available database record of the request table 1054 the following values, if available: CollabSessionID, CollabRequestID, RequestContent, RequestReceivedTime, URLHash, CollabResponseID, ResponseStartTime, ResponseEndTime, and IsClickStream (flag). Further, any values not available are set to null values and the flag value is reset if not already set by the capture component 120 (as discussed previously). Then, the collection component 130 determines (Step 969) whether the CollabResponseID is already in the response table 1056. If not, then the collection component 130 writes (Step 970) into an available database record of the response table 1056 the following values: CollabResponseID and ResponseContent. Finally, if the determination in Step 969 is positive or after Step 970 is performed, the process proceeds to Step 986, described herein.

If the determination in Step 960 is negative, then the collection component 130 assumes that the request has been received “out of order” or “has timed out.” In either case, the collection component 130 searches for an existing session with which the request under consideration may be added and, accordingly, proceeds to Step 972. The collection component 130 next determines (Step 972) whether an ApplSessionID or UserID has been set for this particular BrowserID and EntityID. If not, then the collection component 130 assumes that this is a new session and returns to Step 942 and proceeds accordingly from there. If an ApplSessionID or UserID has been set, then the collection component 130 attempts to match the request under consideration (and associated response) with an existing collaboration session associated with an available ApplSessionID or UserID. To do this, the collection component 130 initiates (Step 974) an “identifySession” protocol. The identifySession protocol forms an interface (Step 976) to the affiliated enterprise application, passing it headers and other relevant fields from the request under consideration in an attempt to isolate the ApplSessionID and/or UserID. The application is requested to return a valid UserID (if one can be determined) and an ApplSessionID (if it exists). If no ApplSessionID or UserID is returned (in Step 978), the collection component 130 assumes that the request under consideration belongs with a new session and returns to Step 942. If an ApplSessionID or UserID is returned (in Step 978), then the collection component 130 next determines (Step 980) based on relevant time sequencing whether the request under consideration represents a continuation of the same application session indicated by the matching ApplSessionID or UserID. If not, then again, the collection component 130 assumes that the request under consideration belongs with a new session and returns to Step 942. If the determination in Step 980 is positive, then the collection component 130 updates (Step 981) the UserID and/or ApplSessionID values associated with the relevant collaboration session, as applicable, and continues on with Step 982. Before explaining Step 982, it should be understood that the identifySession protocol also requests that the affiliated application return a user-specific time-out period value, if one exists in the application for this particular ApplSessionID or UserID; thus, in Step 982, if such a value has been returned, the collection component 130 resets the value for the collaboration timeout period (TimeoutPeriod) in the database record for this CollabSessionID from the default value used by the system 100 to the value returned by the application. After performing Step 984 or if the determination in Step 982 is negative, the process returns to Step 964 to update the tables and database record entries.

Finally, continuing with the process in FIG. 9, the collection component 130 determines (at Step 986) whether the URL in the request under consideration is a “login URL.” Preferably, the system 100 maintains a list of such “login URLs” in a configuration file associated with each affiliated application. A login URL is defined as any URL that might result in the application establishing a new application session (and assigning a corresponding ApplSessionID). Typically, a login URL is the URL invoked by submitting the application's “login” form. Despite the name, however, it is not necessary that the URL be associated with an actual “login” form or that any end user identity be established, only that a new application session be established, or an existing session recognized and continued. For example, the URL of any particular web page in which the affiliated application assigns an application session identifier (ApplSessionID), even if an end user identification (UserID) is not available, is a type of “login URL.” If the determination in Step 986 is positive, the collection component 130 sets (Step 988) the loginpending flag (IsLoginPending). The login-pending flag indicates that either an ApplSessionID should now be available from the affiliated application or that a UserID may be derived from the content of the next request considered for this BrowserID and EntityID.

Next, if the BrowserID and EntityID of the request under consideration match (Step 989) an existing entry in the session table 1052 for which the UserID and/or the ApplSessionID have not yet been determined, another identifySession protocol is invoked (Step 990) to attempt to identify either or both the UserID and the ApplSessionID for this particular session. If not, the process proceeds to Step 1010, discussed hereinafter. As with Step 974, the identifySession protocol forms an interface (in Step 992) with the enterprise application, passing it headers and other relevant fields from the request under consideration in an attempt to isolate the ApplSessionID and/or UserID. The affiliated application is requested to return a valid UserID (if one can be determined) and an ApplSessionID (if it exists). If no ApplSessionID or UserID is returned (in Step 994), the process ends.

If an ApplSessionID or UserID is returned (in Step 994), the collection component 130 next determines (Step 996) whether both the ApplSessionID and UserID in the session table 1052 (for this particular session) are null value(s) and/or the same value(s) as that returned by the affiliated application. In the unlikely event that the determination in Step 996 is negative, the collection component 130 assumes that the request under consideration belongs to a new session and the process returns again to Step 942. If the determination in Step 996 is positive, then the collection component 130 updates (Step 998) the UserID and ApplSessionID values associated with the relevant session in session table 1052 with the value(s) returned by the affiliated application and then continues on with Step 1000. The collection component 130 again determines (Step 1000) whether, in response to the identifySession protocol, the affiliated application returned a user-specific time-out period value, if one exists in the application for this particular ApplSessionID or UserID. If such a value has been returned, the collection component 130 resets (Step 1002) the value for the collaboration timeout period (TimeoutPeriod) for this CollabSessionID from the default value used by the system 100 to the value returned by the affiliated application. After performing Step 1002 or if the determination in Step 1000 is negative, the process ends.

Returning now to Step 986, if the determination in Step 986 is negative (i.e., the URL of the request is not a “login URL”), then the collection component 130 determines (Step 1004) whether the IsLoginPending flag has been set (i.e., whether the previous URL was a login URL). If so, then the IsLoginPending flag is reset (Step 1006). Next the collection component 130 determines (Step 1008) whether the UserID and ApplSessionID have been set to non-null values (e.g., by a previous identifySession protocol). If not, then the process returns to Step 990 to run the identifySession protocol again. If the determination in Step 1008 is positive or the determination in Step 1004 is negative, the collection component 130 next determines (Step 1010) whether the request URL is a “logout URL.” Like the list of “Login ULRLs, ” the system 100 preferably maintains a list of “logout URL” for each application as well. If the determination in Step 1010 is positive, the session terminated flag (IsSessionTerminated) is set (Step 1012); thus, impacting the determination back in Step 958, discussed previously. After Step 1012 or if the determination in Step 1010 is negative, the process ends.

It should be understood that for some affiliated applications, determining what is a “Login” or “Logout” URL may not be readily determinable by the collection component 150. For example, some applications are “hidden” behind a single base URL and/or use hidden form variables to direct the application to perform various functions, such as login or logout, and others. In such situations and in an alternate embodiment of the present invention, it may be necessary specifically to write or configure an “application-specific” adapter for use by or in conjunction with the affiliated application. Creating of such an adapter is within the capability of those skilled in the art. Such adapter is capable of receiving a request forwarded by the collection component 130 and then analyzing the URL, form variables, or cookies, or any combination of the three contained therein, to determine what type of operation, such as login or logout, is being requested of the application.

In another alternative embodiment, it should be noted that Steps 912, 914 (of FIG. 9a), which refer to the “third” layer of filtering performed by the collection component 130 to ensure that duplicate responses from different capture components 120 do not get stored in the database storage 180 duplicate times, may be omitted. The reason for this is because such filtering is also performed by Steps 952 and 969 further in the process described by FIG. 9. In yet a further alternative embodiment, determination Steps 952 and 969 may themselves be omitted if the response table 1056 and database manager 140 are configured in such a way that any attempt to insert a “duplicate” response having the same CollabResponseID (i.e., hash value for the response) into response table 1056, which occurs in Steps 954 and 970, is not allowed or generates a harmless processing “error, ” which is ignored by the collection component 130, which then passively allows the “duplicate” response to be lost or discarded.

C. Database Manager Processes

As described above, the database manager 140 receives session, request, and response data from the collection component 130 and records the same in appropriate tables 1052, 1054, 1056 maintained in database storage 180. The database manager 140 is primarily responsible for interacting with the collection component 130 and for managing and organizing the database storage 180 so that such session, request, and response database records are more easily accessed and searched by the collaboration services component 150, as described hereinafter.

Back End Processes

a. Collaboration Services Component and Presentation Component Processes

The collaboration services component 150 works closely in conjunction with the presentation component 160 to provide a CSR, via a browser running on computer 170, with an off-line or near-real-time replay of a web session of an end user. The collaboration services component 150 is primarily responsible for retrieving requested data from the database storage 180, pre-processing such data, and providing other support functions for the presentation component 160. In contrast, the presentation component 160 is primarily responsible for providing web session data to the CSR's computer 170 in a suitable format for viewing by a browser and with URLs redirected back to the presentation component 160 that enable the web session of an end user to be re-created or replayed without actually accessing the entity's web servers 108 or application servers 110. Preferably, the presentation component 160 comprises a number of separate application modules accessed via a standard web server interface. With the assistance of the collaboration services component 150, these modules produce HTML and Javascript output, which permits the CSR to view a list of sessions associated with a particular end user, view the click stream of a selected session, and then view web pages of the click-stream, including “filled-in” versions of submitted forms and so forth, as retrieved from the database storage 180. Although not described in detail herein, the functions of the collaboration services component 150 preferably are made available to the presentation component 160 through a set of COM+ interfaces, as will be appreciated by one skilled in the art.

Since the processes of the collaboration services component 150 and presentation component 160 are so closely intertwined, they will be described jointly hereinafter with reference to FIG. 5c and FIGS. 11-16. Turning first to FIG. 5c and again with reference to the components illustrated in FIG. 2, the collaboration services and presentation components 150, 160, respectively, perform the following primary functions: they gather (Step 502) session data for an identified user, application session, or browser; they identify (Step 504) which requests (and associated responses) are part of the click stream (i.e., main web pages visited by the end user as opposed to subordinate requests and responses used to complete a previously-requested web page) of a given session; within the click stream, they generally provide (Step 506) lookup and retrieval of resources stored in database storage 180; they reconfigure (Step 508) identifiers that point to resources stored on the entity's web servers 108 and application servers 110 with identifiers that point to the presentation component 160 and to the underlying resources stored in database storage 180; they derive (Step 510) relationships between responses containing html forms and subsequent requests representing submittal of those forms; and they provide (Step 512) a “form fill-in” service, wherein a response containing an html form is combined with a subsequent request representing the submittal of information in that form, creating a web page available to the CSR that graphically displays the state of the filled-in form at the time of submission.

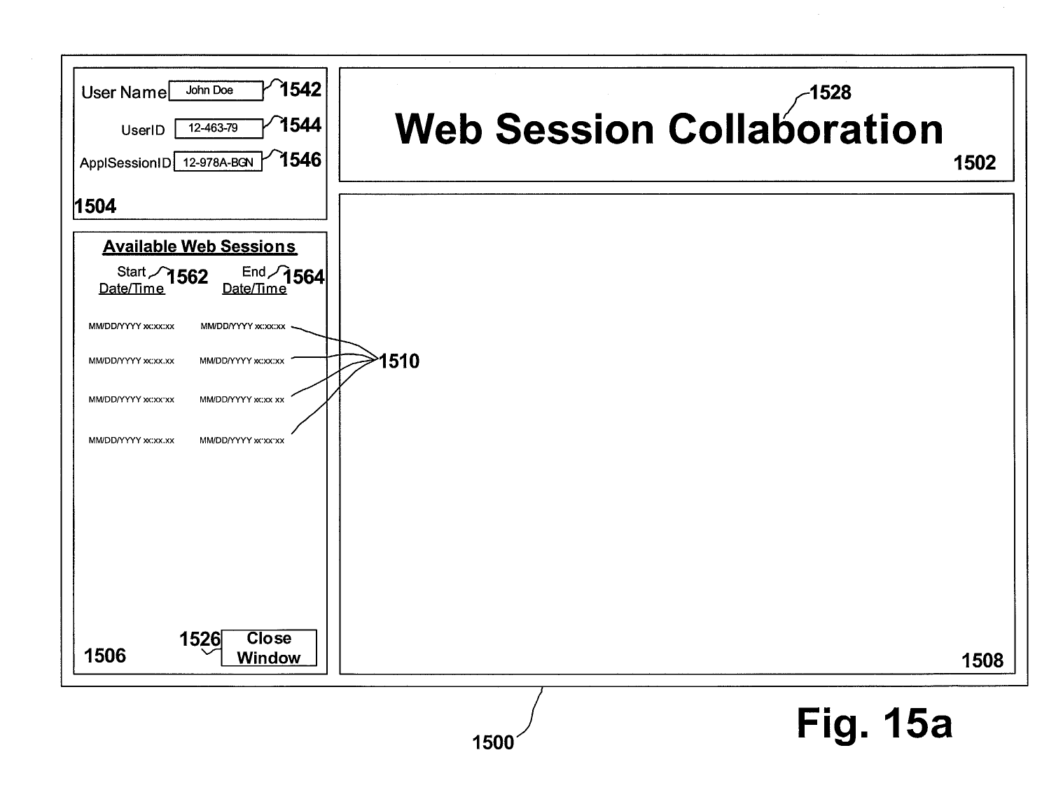

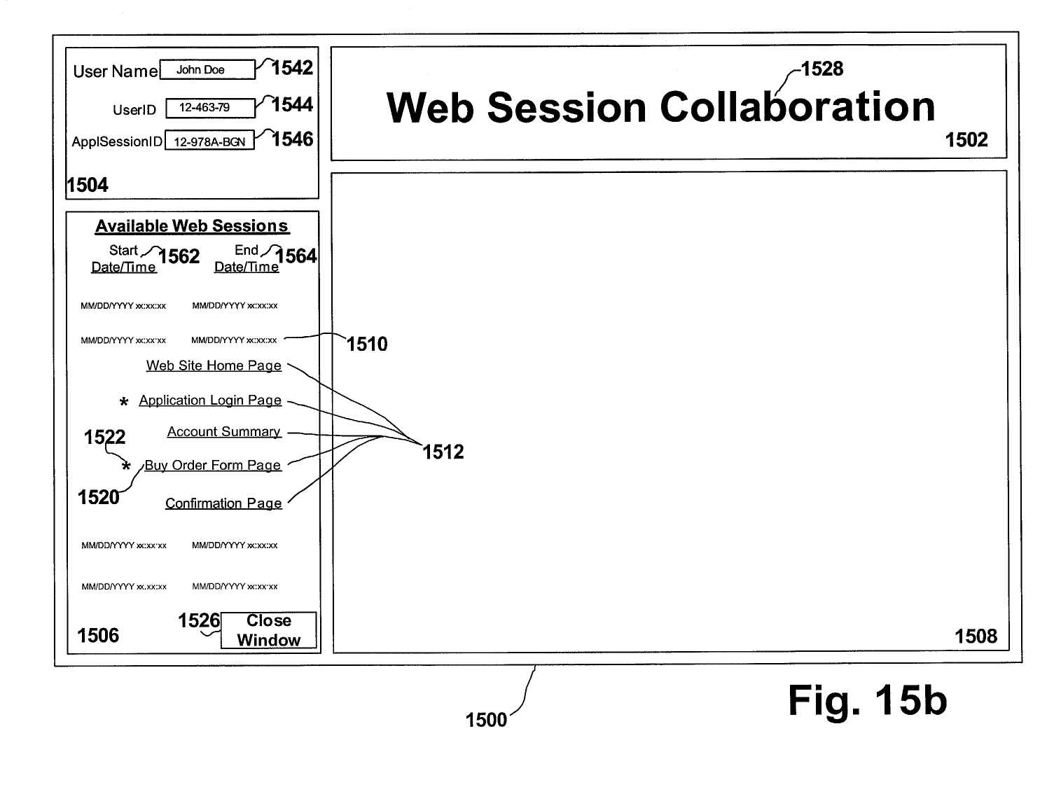

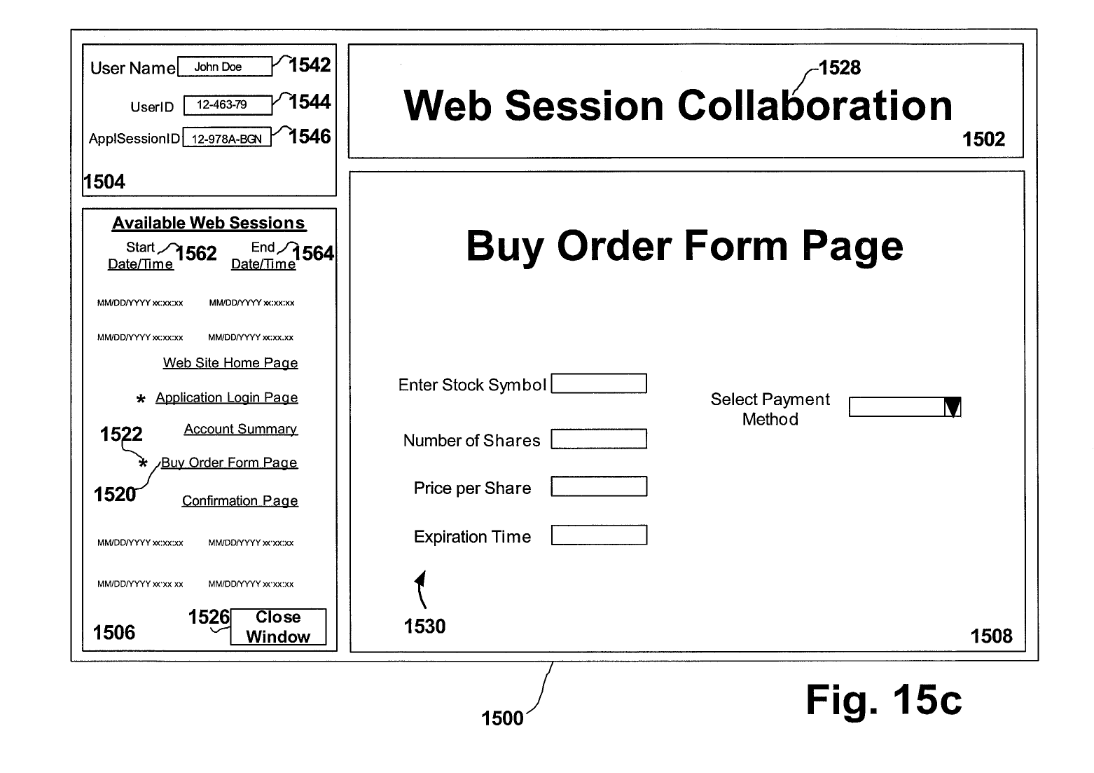

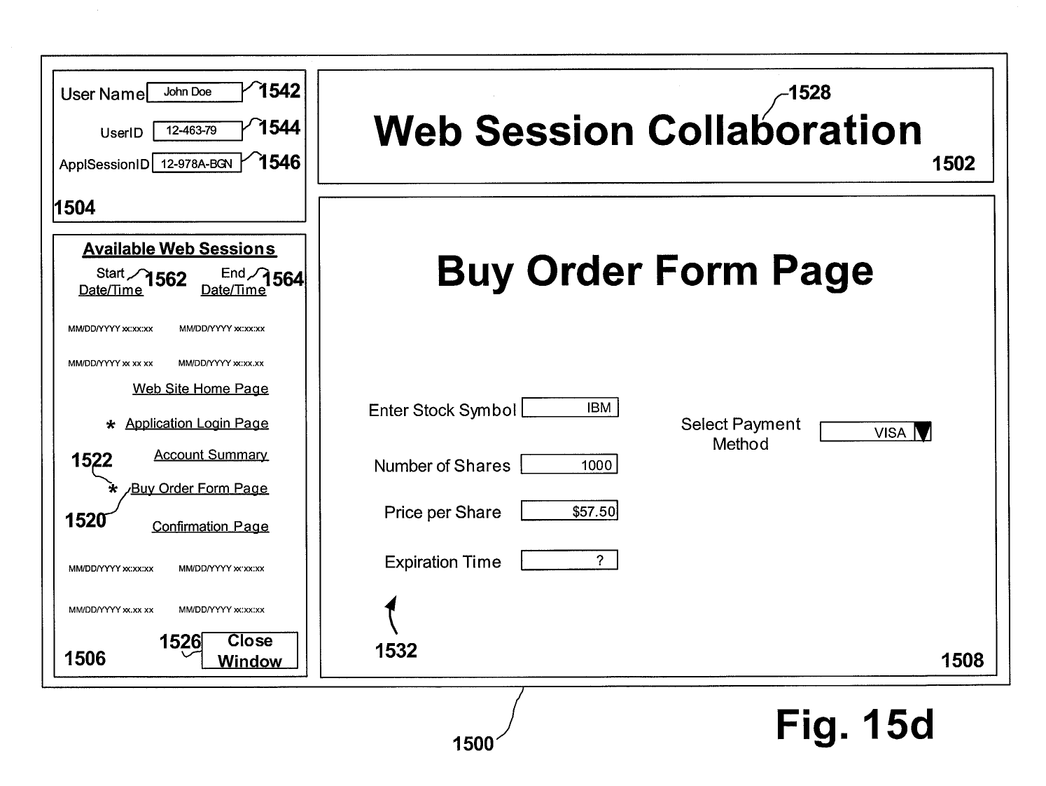

As stated previously, it is not necessary for the collaboration services and presentation components 150, 160 to perform any functions until requested to do so by the CSR. Preferably, the present invention exists in an environment (similar to that previously described in the exemplary transaction of FIGS. 1a through 1i) in which the CSR interacts with an end user by phone, Internet chat, email, or the like using software and hardware that is conventionally or commercially available. For example, WebTone Technologies, Inc., located at 3390 Peachtree Road, Suite 600, Atlanta, Ga., 30326, USA, currently offers a CSR computer application sold under the name of EventTracker™ that ties a CSR's phone system in with the CSR's computer system. For example, if a call is received by the CSR's phone system, it is directed to the first available CSR. If the caller can be identified by callerID, for example, the CSR application retrieves all available information about the caller and presents the CSR, using a browser interface on computer 170, with all such available information. Such information may include name, address, phone number, previous support calls, emails, or Internet chats with the CSR department. If known, the CSR application also retrieves the UserID of the caller associated with one or more affiliated applications. If an email or Internet chat is initiated through the affiliated application, such information may include the UserID and/or ApplSessionID associated with the end user. In some cases, it may be necessary for the CSR to request and obtain additional information from the end user in order to identify name, address, phone number, which would then enable the CSR application to derive a UserID and/or ApplSessionID, based on crossreferenced information contained in a database associated with the application server 110. If the end user has a question that can be answered easily or that does not involve the entity's web site or affiliated application, such issue is handled in conventional manner. However, if the end user has a question or issue that involves the entity's web site or affiliated application, then the CSR initiates the back end processes 194 (from FIG. 4) of the present invention, for example, by activating a “button”) or hyperlink on the CSR application interface. Such hyperlink launches a CSR web session collaboration web page 1500, such as that shown in FIG. 15a. Preferably, the presentation component 160 acts as a web server for generating and providing the web page 1500 to the CSR. In order for the web page 1500 to populate with data, identification of the end user (UserID), the affiliated application session (ApplSessionId), or the browser identification (BrowserID) associated with the computer 102 of the end user must be provided to the presentation component 160. Such UserID, ApplSessionID, or BrowserID may be manually input by the CSR into an appropriate field on an initial start-up screen (not shown) of the CSR web session collaboration web site (i.e., a web page preceding web page 1500) or it may be provided directly by the CSR application when the request for web page 1500 is sent. FIG. 15a illustrates web page 1500 after such UserID or ApplSessionID has been provided to the presentation component 160.

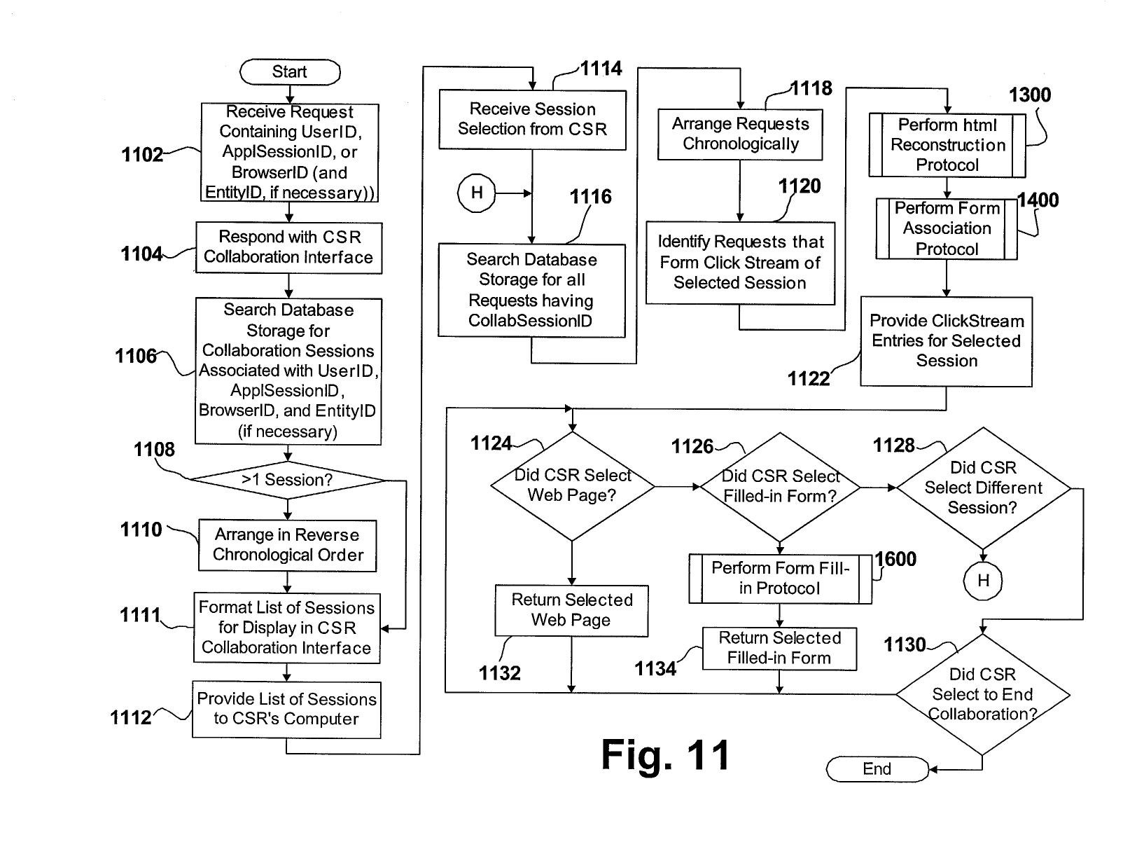

Turning now to FIGS. 11-14, a more detailed flow-chart of the back end processes 194 performed by the collaboration services and presentation components 150, 160 is illustrated. With reference first to FIG. 11 and as stated previously, the back end processes 194 are initiated when a UserID, ApplSessionID, or BrowserID is received (Step 1102) from the CSR (through the CSR interface and/or underlying computer application). If the collaboration services and presentation components 150, 160 interact with CSRs for more than one entity and if there is a potential overlap in UserIDs or ApplSessionIDs between various entities, it is also necessary for the back end processes 194 to receive (or be able to determine) the entity identification (EntityID) as well. Such an EntityID is sent by the CSR (or by the underlying CSR computer application) or it may be determined by the collaboration services component 150 based on the UserID, ApplSessionID, and particular CSR from which the request to initiate the back end processes 194 is received.

In response to the request received from the CSR, the presentation component 160 provides (Step 1104) the browser of the CSR's computer 170 with the CSR web session collaboration web page 1500, as shown in FIG. 15a. Jumping briefly ahead to FIG. 15a, web page 1500 is divided into four different quadrants or frames—although the specific arrangement or presentation of the information on these pages should not be deemed to be a limitation to the broad scope and utility of the present invention. The top, right quadrant 1502 contains the web page title 1528. The top, left quadrant 1504 contains information about the end user, such as the user's name 1542, UserID 1544, ApplSessionId 1546, and the like. The bottom, left quadrant 1506 contains click stream and web session information (as will be described in greater detail hereinafter). The bottom, right and largest quadrant 1508 is currently left blank but will contain a web page once such web page is selected (from quadrant 1506) by the CSR for viewing (as will also be discussed in detail hereinafter). It should be understood that the web page 1500 is shown merely for illustrative purposes and that the exact arrangement and content of information shown is merely one preferred for simplicity and for ease of describing the present invention. Other arrangements and content for web page 1500 are considered to be within the scope of the present invention.

Turning back to FIG. 11, the collaboration services component 150 next searches (Step 1106) the database storage 180 for all sessions associated with the UserID, ApplSessionID, BrowserID, and EntityID (if necessary) provided to the presentation component 160 by the CSR or CSR application (as described previously). If it is determined (Step 1108) that there is more than one collaboration session that is associated with the UserID, ApplSessionID, BrowserID, and EntityID provided, such sessions are arranged (Step 1110) in reverse chronological order and a list of such sessions is provided to the presentation component 150. The presentation component 160 then formats (Step 1111) the list of collaboration sessions for display by the CSR's browser and sends (Step 1112) the list to the browser for display in quadrant 1506 (as shown in FIG. 15a).

Jumping again to FIG. 15a, the list of sessions 1510 are displayed in reverse chronological order from most recent down to oldest with each session preferably shown by its start and end date and time 1562, 1564, respectively (obtained from the SessionStartTime and SessionEndTime information for each session from database storage 180). Some of the formatting performed by the presentation component 160 in Step 1111 involves associating a hyperlink back to the presentation component 160 for each session in the list 1510. Each hyperlink contains information, such as the corresponding CollabSessionID associated with the respective session, to enable the presentation component 160 to know which session, if any, is selected by the CSR for further processing and viewing. Thus, when the CSR selects one of the hyperlinked sessions from the list in conventional manner, the presentation component 160 receives (Step 1114) the corresponding CollabSessionID (embedded in the request from the CSR's browser) and forwards the same to the collaboration services component 150 along with a request for further back end processing. For example, the collaboration services component 150 first searches (Step 1116) the database storage 180 for all requests associated with the specified CollabSessionID. Presumably, these requests are already ordered in the database storage 180 in chronological order; however, the collaboration services component 150 first ensures (Step 1118) that the list of requests are arranged chronologically. Next, the collaboration services component 150 identifies (Step 1120) all requests in the selected session (based on CollabSessionID) that form the click stream of the specified CollabSessionID. More specifically, the IsClickStream flag indicates which requests (and associated responses) of the identified session are part of the click stream.

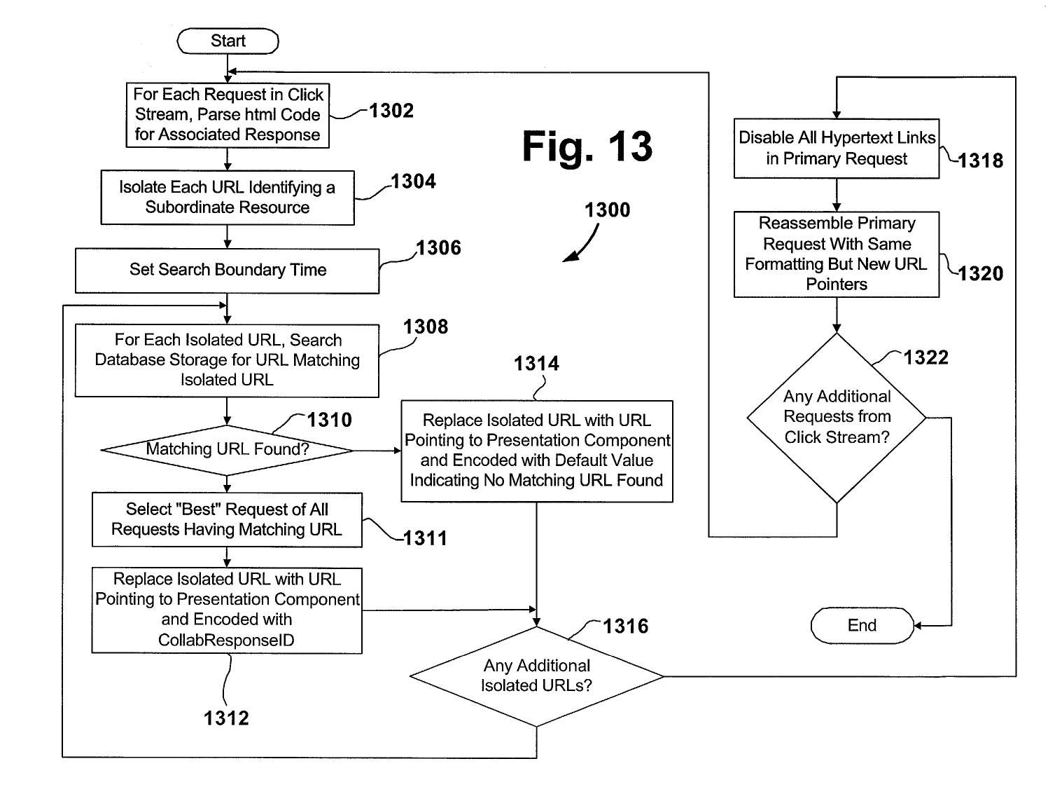

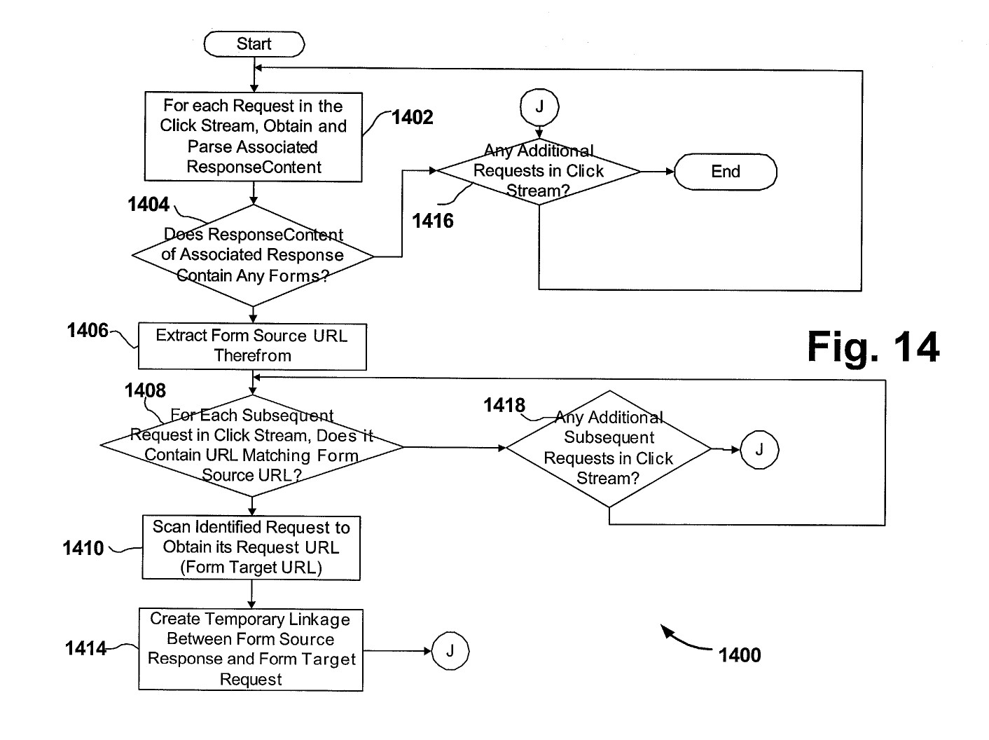

Conceptually, as briefly described above, the “click stream” consists of a sequence of web pages visited by an individual end user of the entity's web site/affiliated application; that is, the sequence of web pages resulting from the end user's mouse clicks. Since the end user's actions are not directly accessible to the capture component 120, however, the notion of a click stream according to the system 100 is only an approximation. Specifically, the system 100 defines a click stream as a sequence of requests captured by the capture component 120 and known to belong to the same session where the associated response is of content type “text/html.” As stated previously, the IsClickStream flag was set for each particular request if its associated response was of a content type “text/html” in Steps 724, 726 in FIG. 7. After identifying which requests in the identified session form the click stream, the collaboration services component 150 performs (Step 1300) an html Reconstruction protocol and performs (Step 1400) a Form Association protocol. Each of these two protocols is described in greater detail hereinafter in association with FIGS. 13 and 14, respectively.

After the above two protocols have been performed by the collaboration services component 150, the presentation component 160 provides (Step 1122) the CSR's browser with an expanded version of the selected session to show the click stream 1512 associated with that session (as illustrated in FIG. 15b).As previously mentioned, it should be understood that, conceptually, the click stream comprises the sequence of web pages visited by the end user. Since one web page may require a plurality of requests and response to complete, only the first or “primary request” and corresponding response is used to identify each separate web page of the click stream. Subordinate or secondary requests and corresponding responses, which are used to “complete” a requested web page, are not considered to form the click stream. As shown in FIG. 15b, each element 1512 of the click stream (i.e., each primary request and associated response) is identified by the “title” of the web page (as obtained from the <TITLE> tag in the html source in the content portion of the response). Like each session identifier provided to the CSR's browser previously, each click stream element is formatted by the presentation component 160 to have a byperlink back to the presentation component 160. Each hyperlink contains enough information to enable the presentation component 160 to retrieve the associated web page, as it is stored in the database storage 180. As is also illustrated in FIG. 15b, some of the elements 1512 of the click stream have a “*” next to it, which indicates that a filled-in version of the associated form is available for viewing by the CSR. The “*” next to a particular click stream element indicates that the associated web page is a blank form (by “blank form” we mean such a form containing only the default or other values inserted by the web server or application server before it is presented to the end user and, obviously, before the end user has input or submitted any such values into the form). For example, by selecting the click stream element 1520 itself, the CSR is presented with the blank web page form 1530 (as shown in FIG. 15c, quadrant 1508). By selecting the “*” 1522 next to the click stream element 1520, however, the CSR is presented with the filled-in web page form 1532 (as shown in FIG. 15d, quadrant 1508). It should be understood again that the collaboration service component 150 provides the presentation component 160 with the necessary identifier information so that the filled-in form can be accessed by the CSR merely by clicking on or otherwise activating the “*,” as shown in FIGS. 15b, 15c, and 15d.

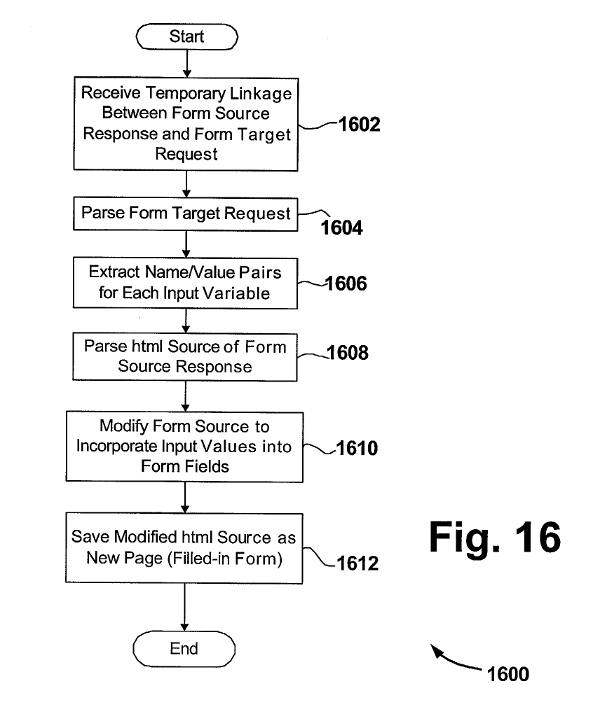

Thus, returning to FIG. 11, the presentation component 160 cycles through Steps 1124, 1126, 1128, and 1130 waiting for the CSR to make another selection on the CSR web session collaboration web page 1500. If the CSR selects to view one of the web pages from the click stream, the determination in Step 1124 is positive and the presentation component 160 returns (Step 1132) the selected web page (e.g. blank form 1530 in FIG. 15c). If the CSR selects to view one of the filled-in forms from the click stream, the determination in Step 1126 is positive and the presentation component 160 performs a Form Fill-in protocol (Step 1600), which is described in detail hereinafter in association with FIG. 16. Once the Form Fill-in protocol (Step 1600) is completed, the selected filled-in form (e.g., filled-in form 1532 in FIG. 15d) is provided (Step 1134) to the CSR. If the CSR selects to view a different session, the determination in Step 1128 is positive and the presentation component 160 returns to Step 1116 and proceeds from there in association with the newly-selected session. If the CSR selects to end the collaboration session (for example, by selecting the “Close Window” button 1526, as shown in FIGS. 15a, 15b, 15c, and 15d), the determination in Step 1130 is positive and the collaboration (and back end processes 194) ends.

Turning now to FIG. 13, the htmlReconstruction protocol 1300 is illustrated. Before addressing each step of the protocol 1300, it should be understood that when the collaboration services component 150 retrieves an HTML-formatted document (i.e., web page) from the database storage 180, it must pre-process the document before returning it to the presentation component 160. One goal of the pre-processing is to ensure that any hypertext links or form submittal buttons in the returned document are disabled. These links are typically customized to an end user's account, session, or other context at the time they are produced. Allowing the CSR to access such links or form submittal buttons is both potentially dangerous to the security and integrity of the entity's web application, and unlikely to produce meaningful results. Two other goals of the pre-processing steps are: (i) to determine which documents stored in the database storage 180 (if any) should be returned in response to subordinate requests and responses in order to display the same (or nearly the same) web page to the CSR as was previously viewed by the end user; and (ii) to encode the information needed to communicate that information to the presentation component 160 and browser of the CSR's computer 170.

For example and as stated previously, a typical HTML web page includes a number of references to subordinate images encoded through the use of image (HTML <IMG>) tags, as well as style sheets and other supporting content identified through link (<LINK>) tags. Hence, when a browser requests a web page (using a primary request and associated response), it is appropriate to expect that the content identified by any <IMG> or <LINK> tags will soon be requested (by subordinate requests and responses). Determining what content should be returned to satisfy these subordinate requests is complex. Since the HTTP protocol is stateless, each resource request received from an end user's web browser stands alone and any relationship of the resource request with any previously fulfilled request can only be heuristically determined. Furthermore, browser configuration options (e.g. whether images should be automatically loaded), browser caching and other caching (by an intervening web proxy server, for example) may have a significant impact on the stream of HTTP requests observable by a given web server 108 or web server farm. Also, images and other embedded content may be either static or dynamically generated. Hence, it is frequently not possible to determine with complete accuracy which data object should be returned. For this reason, it is necessary for the collaboration services component 150 to make a “best guess” as to which object should be returned in response to each subordinate request and response.

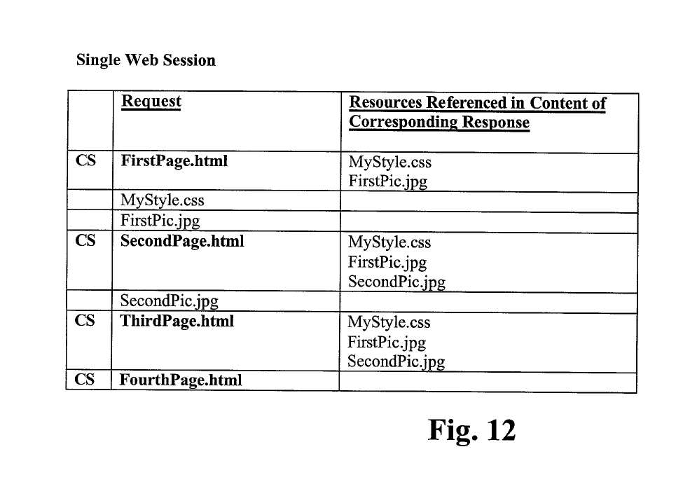

As shown in FIG. 12, each session within the database storage 180 contains, in essence, a sequence of time-ordered requests intercepted by the capture component 120 along with the corresponding responses. Within this sequence, non-click stream request/response pairs—those with non-HTML format data—are interspersed with the click stream pairs. The table in FIG. 12 displays a simplified sequence of captured request/response pairs within a single web session (the requests marked with “CS” represent the click stream). Note that even though FirstPage.html, SecondPage.html and ThirdPage.html all reference MyStyle.css and FirstPic.jpg, the image and style sheet files typically are only retrieved once by the end user's browser because an ordinary static content file is cached by the browser and there is no need to retrieve it again.

Before returning each click stream request and corresponding response to the presentation component 160 for subsequent provision (in Step 1122) to the CSR's web browser for display, the collaboration services component 150 performs a number of pre-processing steps on it. As shown first in FIG. 13, starting with the first request and proceeding through each request in the identified click stream (i.e., for each request in the identified session for which the IsClickStream flag is set) until the last request is processed, the collaboration services component 150 parses (Step 1302) the HTML code for each associated response. The URL identifying each subordinate “document” is isolated (Step 1304). For example, in the HTML code <IMG SRC=“xyz.jpg”>, the URL is the string “xyz.jpg” (without the quotation marks). In a LINK tag, the target URL is provided by the HREF attribute. Next, a request search boundary time is derived (Step 1306). Typically, this search boundary time includes all requests and responses within the click stream up to but not including the next request and response in the click stream after the one currently under consideration. In other words, this is the time before which a request would have had to arrive at the web server(s) in order to be considered a candidate for fulfillment of a subordinate document or subordinate resource request. Then, for each URL isolated by the above procedure, and starting with the first isolated URL and continuing until the last isolated URL, the collaboration services component 150 searches (Step 1308) the request database table in database storage 180 for any request having a URL that matches the previously-isolated one and which was received prior to the search boundary time. Preferably, for efficiency reasons, the search begins with the request and corresponding response closest to the search boundary time and proceeds in reverse chronological order therefrom.

If there are no matches (as determined in Step 1310), the URL in the HTML code is replaced (Step 1314) with a predefined URL string representing no matching URL. It should be noted that if the web page contains references to URLs not located on the same site as the web page, such URLs do not generate a match and, hence, are not requested by or returned to the presentation component 160. On the other hand, if there is a match (as determined in Step 1310), one of the requests matching the query is selected (Step 1311), with the following criteria used to choose among the candidates: (i) a request whose associated response was delivered to the same browser (as determined by BrowserID) as that to which the click stream web page was delivered is preferred over a request whose response was delivered to some other BrowserID; (ii) a request whose associated response was delivered to the same end user (as determined by UserID) as that to whom the click stream web page was delivered is preferred over a request whose response was delivered to some other user; and (iii) the latest matching request is preferred over earlier versions. Next, once a matching request has been selected, the collaboration services component 150 replaces (Step 1312) the URL in the click stream web page's HTML code with a predefined URL string in which the ResponseID associated with the matching request has been encoded. This predefined URL redirects the CSR's browser to the presentation component 160 and directs the presentation component 160 to the proper resource (request and/or response) in the database storage 180. In Step 1316, the collaboration services component 150 determines whether there are any additional isolated URLs in the particular click stream request being reconstructed. If so, the process loops back to Step 1308 to continue processing each isolated URL within this particular request of the click stream (as stated previously). If not, the process continues on to Step 1318.

In Step 1318, the collaboration services component 150 disables or removes all other hypertext links and any form submittal action URLs embedded within the HTML code of the current click stream request to prevent inadvertent activation by the CSR. This is accomplished by simply removing the HREF attribute from any <A> tags and the ACTION attribute from any <FORM> tag. Next, after all embedded URLs have been processed and rewritten as described above in Step 1318, the entire HTML web page is reassembled (Step 1320) with the same structure but using the newly derived URLs.

Finally, in Step 1322, the collaboration services component 150 determines whether there are any additional requests within the particular click stream of the identified session that need to be processed as described above. If so, the process loops back to Step 1302 to repeat the above-described process 1300 for the next request within the click stream. If not, the htmlReconstruction protocol 1300 ends.

Turning now to FIG. 14, the Form Association protocol 1400 is illustrated. Before explaining each of the steps of protocol 1400, however, it should be understood that responses associated with a click stream from a typical web site consist of a mix of ordinary HTML content and HTML forms. When forms are filled-in by the end user and submitted to the web server 108, a conceptual linkage is formed between the original page's URL (the form source) and the URL to which it is submitted (the form target). The form source is typically identified within a response of a request and corresponding response within the click stream. In contrast, the form target is typically identified within a subsequent request of a request and corresponding response also within the same click stream. In most cases, the form source and the form target are found in consecutive request/response pairs in the click stream sequence; however, there is nothing to prevent the insertion of other apparently extraneous requests and/or responses between the form source and the form target. For example, this might occur when an end user clicks on “help” links while filling out the form. In order for the CSR to be able to view a form in its logical state just prior to its submission by the end user, it is first necessary for the steps of the Form Association protocol 1400 to be performed, as described hereinafter. Once such necessary link has been made between the form source and form target pursuant to the Form Association protocol 1400, the Form Fill-in protocol 1600 (as shown in FIG. 16) is readily able to re-create the filled-in form for viewing by the CSR during a collaboration session between the CSR and an end user.

As shown in FIG. 14 and starting with the first request of the click stream of the selected session and proceeding through each request of the same click stream, the collaboration services component 150 obtains and parses (Step 1402) the HTML for the associated response of each request in the click stream to determine (Step 1404) whether it contains any forms. A form is indicated by the presence of properly formatted HTML <FORM> tags. If the response under consideration (in Step 1404) contains one or more forms, the collaboration services component 150 extracts (Step 1406) the form source URL from each form's ACTION attribute contained in the response contents. If the response under consideration does not contain any forms (as determined in Step 1404), then the collaboration services component 150 determines (Step 1416) whether there are any additional requests (and corresponding responses) in the click stream that need to be checked for forms. If there are, then the process 1400 returns to Step 1402 for the next request in the click stream. If not (i.e., there are no more requests and corresponding responses left in the current click stream), then the Form Association protocol 1400 ends.

Next, for each subsequent request in the identified click stream, the collaboration services component 150 examines (Step 1408) the request to determine whether it contains any URLs that match the form source URL obtained in Step 1406. If the determination for the current request is negative in Step 1408, the collaboration services component 150 determines (Step 1418) whether there are any additional subsequent requests in the click stream. If so, then the process returns to Step 1408 to examine the next request in the click stream. If not, then the process returns to Step 1416 to determine if there are any additional requests (and corresponding responses) in the click stream that need to be examined for forms. If the determination in Step 1408 is positive, then the collaboration services component 150 next scans (Step 1410) the identified request of the click stream to obtain its request URL. Next, this URL is identified as the “form target URL” for this particular form. Next, the collaboration services component 150 creates (Step 1414) a temporary linkage between the response containing the form and the subsequent request containing submittal of information within the form—such linkage being tied to the form source and form target URLs.

Turning now to FIG. 16, the collaboration services component 150 begins the process of creating a “filled-in” form web page. The reason such a web page needs to be created is because such a web page does not actually exist anywhere within the system 100—it only existed temporarily within the browser and on the screen of the end user's computer 102 at the time of its submittal. To re-create such a web page, it is necessary to combine the blank form provided by the web server 108 with the information input into the form and sent back to the web server 108 by the end user. It should first be recalled that the Form Fill-in protocol 1600 is invoked or initiated only when the CSR requests to view a filled-in form (in Step 1126 of FIG. 11; e.g., by selecting “*” 1522 next to the form web page 1520 in FIG. 15c). It should also be noted that the collaboration services component 150 has already created a temporary linkage between the form source response and subsequent form target request (as just described in association with Step 1414 in FIG. 14).

With this in mind, the process of re-creating the filled-in form web page begins when the collaboration services component 150 retrieves (Step 1602) the temporary linkage information between the form source response and the subsequent form target request for the form specifically selected by the CSR in Step 1126 (of FIG. 11). Next, the collaboration services component 150 parses (Step 1604) the request containing the form target URL. The set of input variables delivered in the form target request are extracted (Step 1606) from the request to create a list of name/value pairs, one for each variable provided. If the form target request includes an HTTP POST method, the input variables are assumed to reside in the “body content” portion of the request, otherwise, form variables are assumed to be embedded in the request URL preceded by the ‘?’ character and each separated by an “&” character. Next, the HTML source for the form source response is parsed (Step 1608), creating an in-memory data structure representing the entire HTML document. The HTML form source is then modified (Step 1610) to incorporate the new input variable values into the form (e.g., a “text=______” is added to each INPUT line of the relevant form). For each input variable in the name/value list created in Step 1606, if the form source contains an HTML form variable by that name, the value of the variable is modified to cause the change specified in the form submission (e.g., the ______ after the “text=” is modified to include the relevant variable value). Finally, once all of the values have been added to the form HTML source code, the collaboration services component 150 saves (Step 1422) the web page as an entirely new web page. The new web page is associated with the web page containing the blank form but is not considered to be part of the click stream. At this point, the Form Fill-in protocol 1600 ends and the actual filled-in form is returned to the CSR's browser on computer 170 (pursuant to Step 1134 (from FIG. 11) and displayed to the CSR.

Guaranteed Session History and Non-Repudiation of Web Session Transaction

In a further aspect of the present invention, additional (optional) steps may be added to the front end processes 192 (of FIG. 3) and to the back end processes 194 (of FIG. 4) to improve the reliability of the system 100 by ensuring that a “guaranteed session history” is used to re-create and replay a web session of an end user. More specifically, the procedures described herein ensure that the data from database storage 180 used to re-create and replay the web session is the same data that was captured and collected originally by the system 100 contemporaneously or shortly after the actual web session occurred.

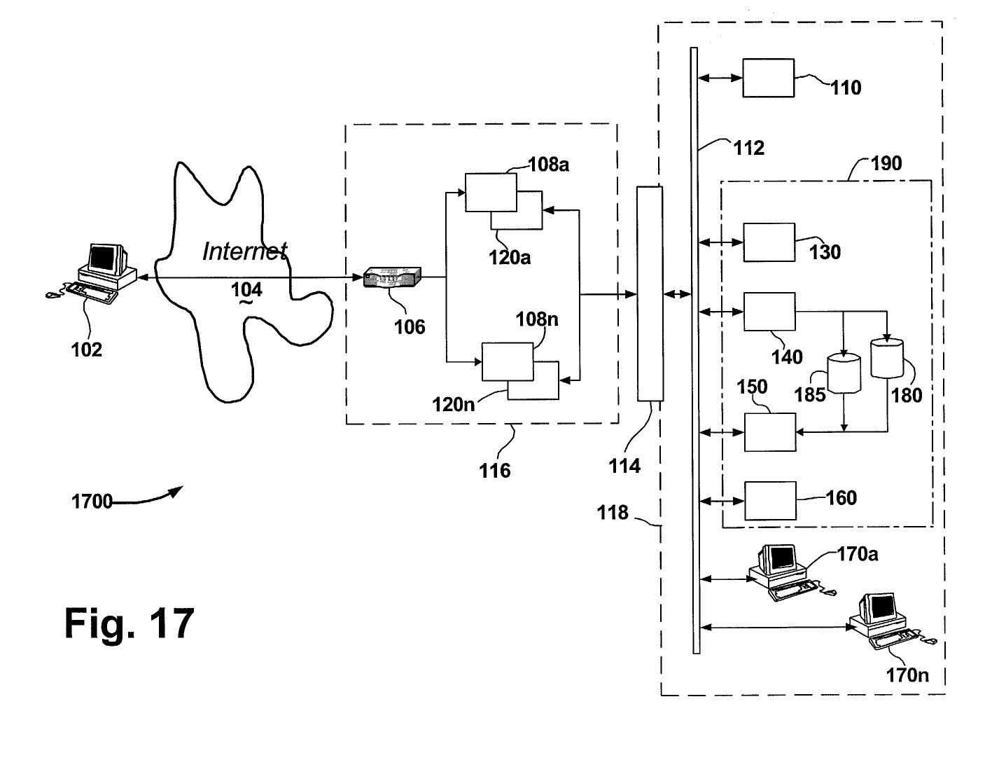

Turning first to FIG. 17, the guaranteed session history described above is facilitated by collaboration and web session capture system 1700. System 1700 is essentially the same as system 100 from FIG. 2, with the notable addition of a “secure” certificate and digital signature database storage 185. Although database storage 180 is itself secure and could be used to store digital signatures and x.509 digital certificates, as will be discussed herein, for integrity reasons and for ease in describing this aspect of the invention, the secure database storage 185 will be considered distinct and isolated from the database storage 180. Although not shown in FIG. 17, secure database storage 185 may be located at a remote location separate from the rest of the network for additional security and integrity reasons.

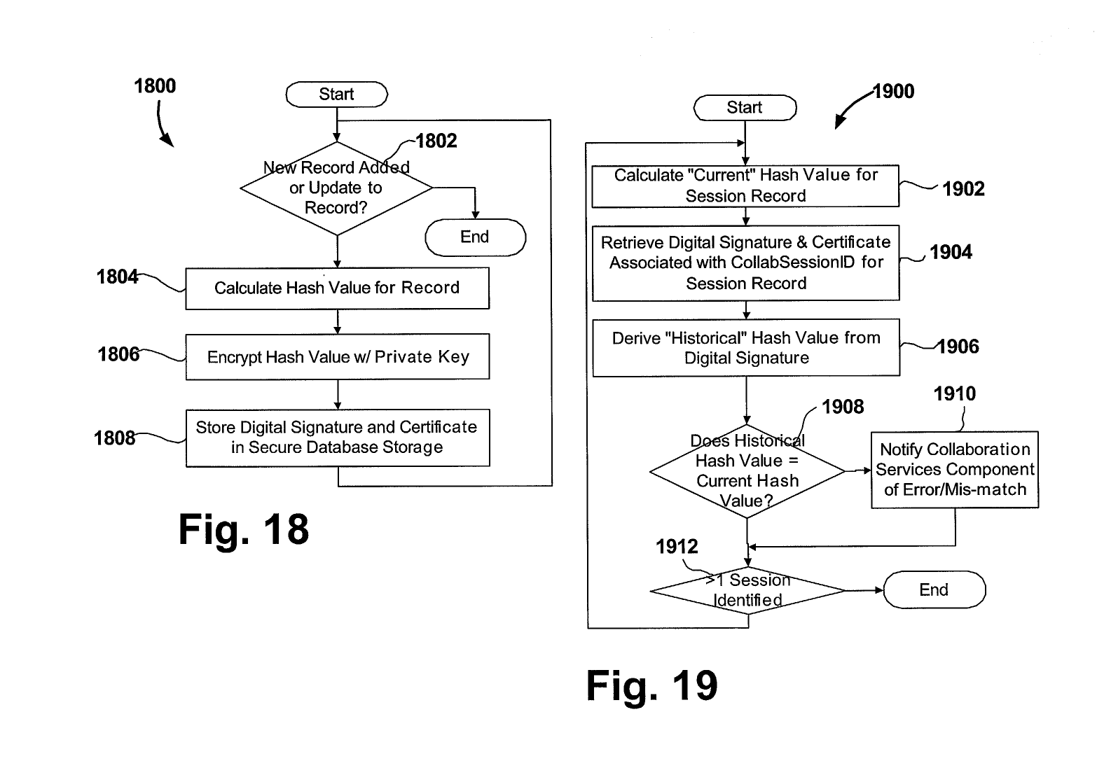

The use of such secure database storage 185 will now be described. At the completion of each collection component process 300 discussed previously in conjunction with FIGS. 5b and 9a-9c (i.e., at each “end” point illustrated in FIGS. 5b and 9a-9c), the collection component 130 further initiates a front end guaranteed session history protocol 1800, which is not shown in FIGS. 5b and 9a-9c, but which will now be described in association with FIG. 18. As shown, the front end guaranteed session history protocol 1800 starts with a determination in Step 1802. If any record in session table 1052, request table 1054, or response table 1056 has been added or if any record in such tables has been updated by the collection component process 300 during its normal operation, then the determination in Step 1802 is positive, and the front end guaranteed session history protocol 1800 proceeds to Step 1804. If the determination in Step 1802 is negative, the process 1800 merely ends, which completes the collection component process 300. It should be understood that any record inserted into the session table 1052, request table 1054, or response table 1056 and any modifications made to any such record outside of the normal collection component process 300 do not trigger Step 1802 to reach a positive determination.

If a record has been added or updated appropriately, the process generates a digital signature for the relevant record first by calculating (Step 1804) a hash value for the relevant record that was added or updated. This hash value is then encrypted (Step 1806) using a private key (of a public/private key pair) in conventional manner, the private key being maintained by the collection component 130 (or elsewhere in the collaboration server arrangement 190) for this specific purpose. This digital signature (i.e., encryption of the hash value of the relevant record) is next recorded (Step 1808) in secure database storage 185 in association with an x.509 certificate (or comparable) and in association with the relevant CollabSessionID, CollabRequestID, or CollabResponseID, as the case may be. It should be noted that an x.509 certificate (which merely “guarantees” the association between the identity of an entity and its public key) is not needed if the entity is merely interested in ensuring the integrity of its data for its own internal purposes since it can, presumably, ensure for its own benefit that it has its own public key. The x.509 certificate (or comparable), however, is used to provide third parties with assurance of such association, if necessary. The front end guaranteed session history protocol 1800 then the loops back to Step 1802 to determine if there have been any other records added or updated that need to be process herein.

To complete the guaranteed session history, a corresponding back end guaranteed session history protocol 1900 is then initiated immediately after Step 1106 (from FIG. 11). As will be recalled, Step 1106 involves a search of the database storage 180 by the collaboration services component 150 to identify collaboration sessions associated with the UserID, ApplSessionID, or BrowserID provided by the CSR or CSR interface. Once the collaboration services component 150 has successfully identified all applicable sessions (by CollabSessionID), the back end guaranteed session history protocol 1900 runs. Turning now to FIG. 19, the back end guaranteed session history protocol 1900 first calculates (Step 1902) a “current” hash value for the record from session table 1052 corresponding with the first retrieved session (by CollabSessionID). Next, the digital signature and x.509 certificate (containing the entity's public key) corresponding with the same CollabSessionID are retrieved (Step 1904) from secure database storage 185. Next, the “historical” hash value associated with the CollabSessionID is derived (Step 1906) by applying the public key from the retrieved x.509 certificate to the retrieved digital signature in known manner (i.e., by decrypting the digital signature). The “current” hash value is then compared (Step 1908) with the “historical” hash value obtained from the digital signature. If the two values are not the same, then the data associated with the relevant CollabSessionID has become corrupt or has been otherwise modified inappropriately (i.e., outside the context of the collection component processes 300) and the collaboration services component 150 is notified (Step 1910) of such data corruption or error. Although not described herein, the collaboration services component 150 can handle such error notification in many ways, for example, by not making such session available to the CSR or by suitably notifying the CSR that such data is potentially suspect, and the like. If the two values are the same or after Step 1910 has occurred, the back end guaranteed session history protocol 1900 next determines (Step 1912) whether there are any other sessions that need to be verified as described above. If so, the process returns to Step 1902. If not, the process ends, which means that the process in FIG. 11 continues with Step 1108.

Although the above-described back end guaranteed session history protocol 1900 only refers to session records, the same process is also preferably repeated for both request and response records to ensure the accuracy of such records from the request and response tables. Such process preferably runs immediately after Step 1116 (from FIG. 11) after the collaboration services component 150 has conducted a search to obtain and identify all relevant requests (and corresponding responses) associated with a specific collaboration session.

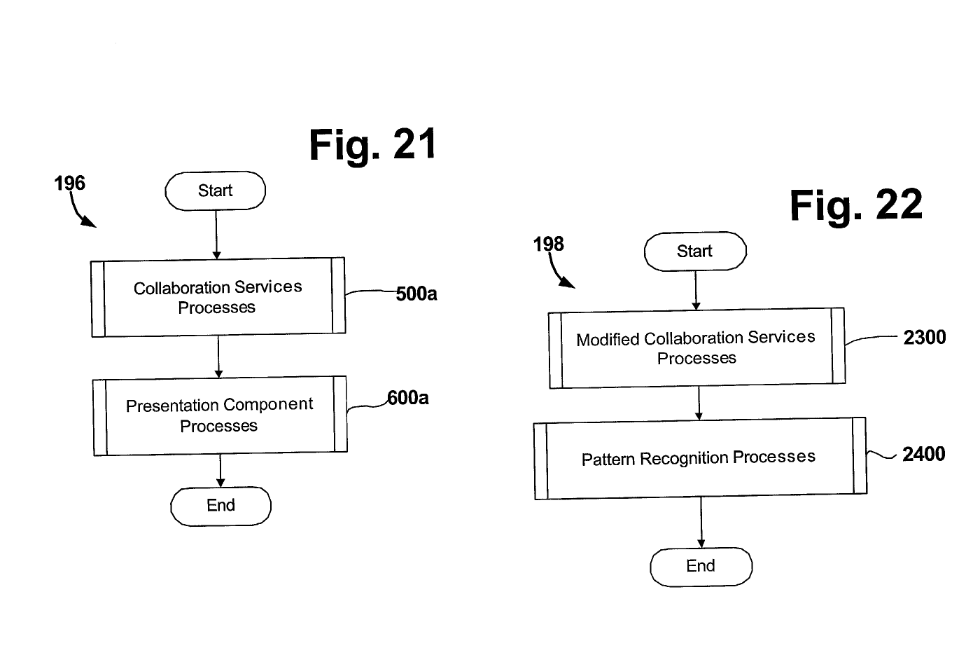

In yet a further aspect of the present invention, alternative back end processes 196, as shown in FIG. 21 and which comprise collaboration services processes 500a and presentation component processes 600a, are implemented after the front end processes 192 (of FIG. 3) have already been performed for a particular web session. These alternative back end processes 196 are used not only to prove the reliability of the captured web session to the end user but potentially also to enable the entity to obtain non-repudiable proof that a particular end user has viewed and confirmed the replay of a given web session. Collaboration services processes 500aand presentation component processes 600a are essentially the same as collaboration services processes 500 and presentation component processes 600 described previously in association with FIGS. 4 and 11-16. The main distinction, however, is that instead of (or in addition to) generating a replay of the web session for review by a CSR, the replay is generated specifically for review and potential confirmation by the end user.

For example, as shown in the “optional” insert below FIG. 1i, once a customer 50 has completed a web session, with or without involvement by the CSR 60, the customer can select (from an appropriate button or link on the entity's web site; not shown) to initiate “playback” of the web session. Alternatively, in some situations, the entity may require “playback” and acceptance by the customer of the web session, as captured, upon completion of an electronic transaction in order to create or to attempt to create a legally binding contract between the customer 50 and the entity. Playback of the web session should not be confused with mere renavigation of the web site by the customer 50 or by the customer's browser, for example, using the “forward” and “back” buttons, which are conventionally provided by browser software, to review cached copies of the web session maintained on the computer 102. Instead, “playback” actually initiates the back end processes 196 to recreate the web session as it was captured and collected on the collaboration server arrangement 190, as discussed previously.

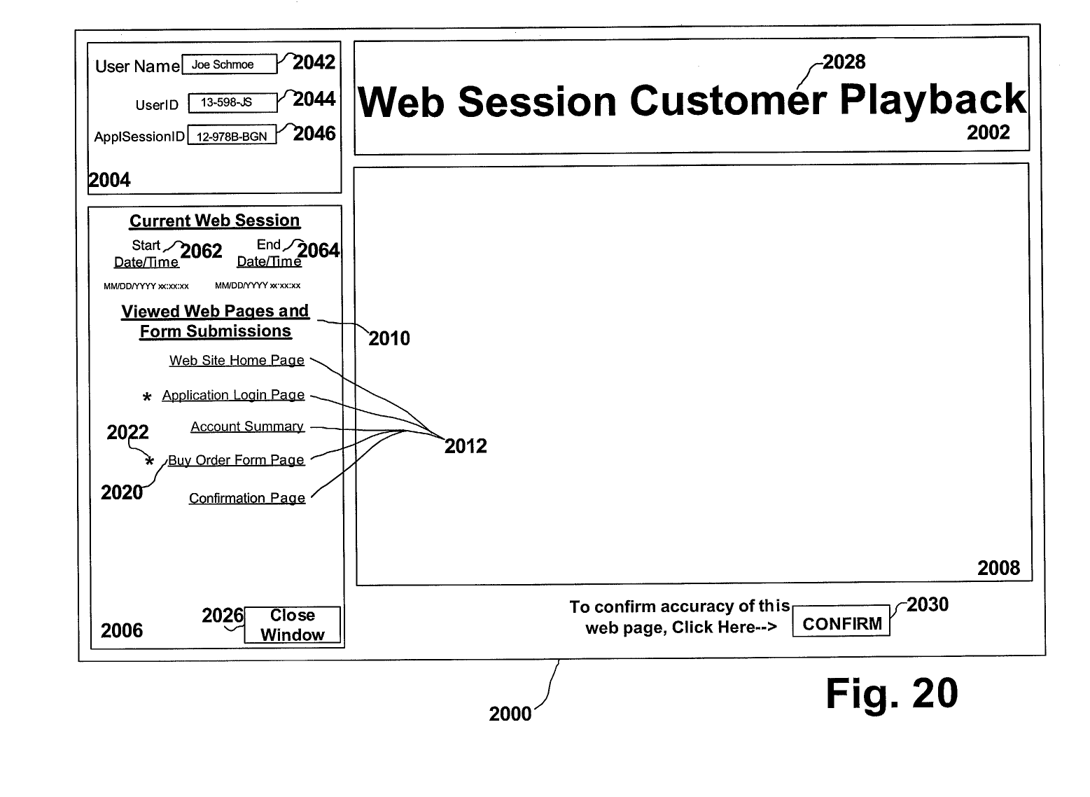

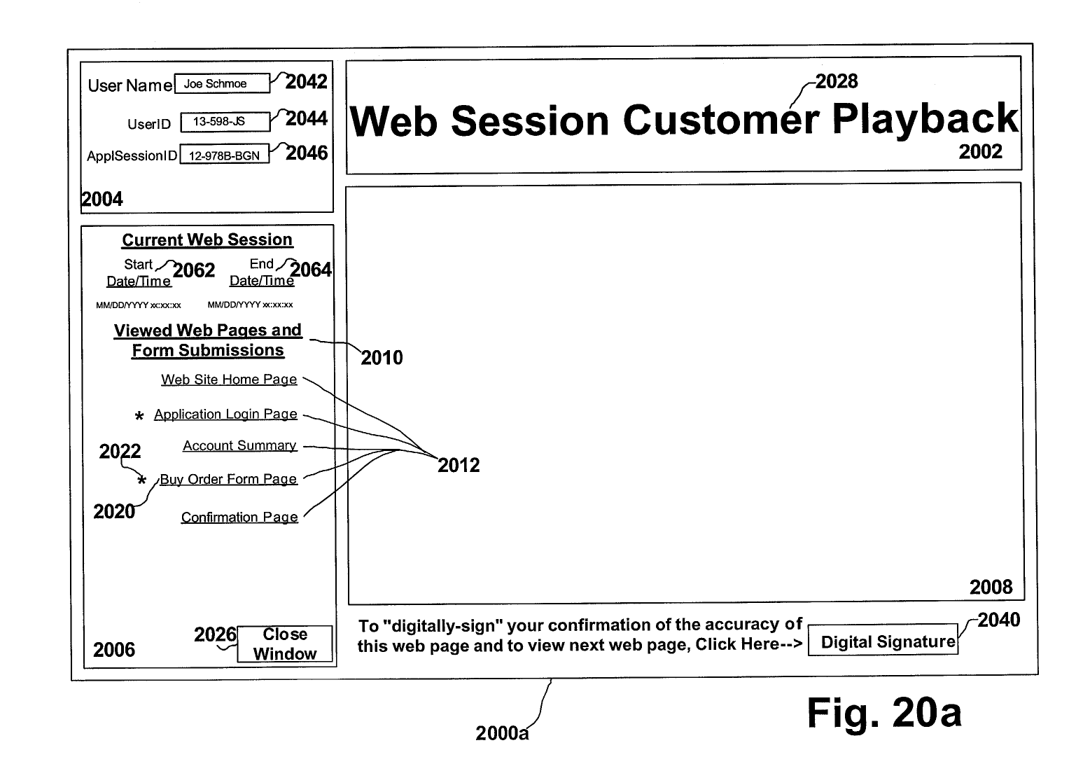

Again, instead of launching the CSR web session collaboration web page 1500 so that the CSR 60 is able to view the captured web session, the customer 50 initiates a “playback” session, which redirects the customer's browser to a customer playback web page 2000, as shown in FIG. 20. Preferably, such connection is established through a secure communication channel using secure socket layers (SSL) or the like, as is conventional. The customer playback web page 2000 is similar to the CSR web session collaboration web page 1500 from FIGS. 15a-15d; however, the playback is, preferably, only provided for the web session and transaction just completed by the customer 50. In alternative embodiments, not shown, the customer is able to view historical web sessions in a manner similar to the CSR.

As shown in FIG. 20, web page 2000 is preferably divided into four different quadrants or frames—although, as with FIGS. 15a-15d, the specific arrangement or presentation of the information on these pages should not be deemed to be a limitation to the broad scope and utility of the present invention. The top, right quadrant 2002 contains the web page title 2028. The top, left quadrant 2004 contains information about the customer, such as the customer's name 2042, UserID 2044, ApplSessionId 2046, and the like. The bottom, left quadrant 2006 contains information regarding the customer's current web session (or portion of a web session, such as only those pages relevant to the transaction) available for replay and review, such as start time 2062 and end time 2064 (i.e., as determined by the collaboration server arrangement 190, which is preferably the time at which the playback session was launched) and each of the web pages and forms 2010 viewed and/or submitted by the customer. Alternatively, as stated previously, if the playback session is launched for the purpose of attempting to create a legally binding transaction, it is only necessary for pages from the web session relevant to the transaction to be listed in quadrant 2006. Each individual web page 2012 is pre-processes in the same manner described above before it is presented in page 2000. For example, hyperlinks associated with each web page listed are directed to the presentation component 160 and appropriate request and response content in database storage 180 rather than to the web server 108, application server 110, and cache memory of computer 102—so that the replay is of web pages stored in the database 180. It should be noted that “blank” forms 2020 (i.e., forms as originally presented to the customer by the web server) may be viewed as well as the same forms 2022 as filled-in and submitted by the customer 50, which is designated by the “*” next to the blank form web page name. The customer 50 is able to close the window at any time by selecting the close window button 2026.

Once any page is selected by the customer, it is displayed in the bottom, right and largest quadrant 2008, which is currently left blank but which will contain a web page once such web page is selected (from quadrant 2006) by the customer 50 for review. The playback web page 2000 also contains a button 2030 by which the customer is able to “confirm” the accuracy of the web page reviewed in quadrant 2008. Preferably, this button does not appear or cannot be activated by the customer 50 until a replayed web page is actually displayed in quadrant 2008. When the confirmation button 2030 is selected, it sends a request back to the presentation component 160, which is acting as the web server for the playback session, which provides the entity with some security in knowing that the displayed web page has at least been viewed by the customer 50 and actively “confirmed” by the customer. Preferably, the confirm button 2030 does not become “active” for a brief, predetermined delay period after the web page has been displayed in quadrant 2008. Such delay ensures that the customer does not accidentally activate the confirm button 2030 on successively viewed web pages. In an alternative embodiment, the customer 50 is not permitted to view the “next” web page in the sequence until the current web page has been approved. In such embodiment, clicking the confirmation button 2030 moves the customer to the next web page in the sequence. In such an alternative embodiment, it may be desirable not to show the entire list of web pages 2012 to be viewed since the customer is not permitted to advance to unseen pages. In another embodiment, the confirmation button 2030 is not presented until after the customer 50 has viewed all pages in the session (or relevant to the transaction). In yet another alternative embodiment, as shown in FIG. 20a, the customer 50 is presented with a “confirm and digitally-sign” button 2040. The “confirm and digitally-sign” button 2040 may be used instead of or as a follow-up to the confirmation button 2030 from FIG. 20. When the confirm and digitally-sign button 2040 is activated by the customer, a suitable applet running on the customer's computer 102 and compatible with the browser software launches. Such applet, not shown, enables the customer to save and digitally-sign the page currently being displayed. Such digital signature, along with an appropriate x.509 certificate (or comparable), is provided to the collaboration server arrangement 190 by the applet or by the browser running on the customer's computer 102 for suitable storage in secure database storage 185. Again, such digital signature may be applied to each web page as it is viewed or to the series of web pages viewed.

In an alternative embodiment, the collaboration server arrangement 190 provides the “digital signature applet” running on the customer's computer 102 with the hash value computed for each record (session, request, and response) that makes up the customer's session or transaction. The hash values for each record are computed in the same manner as described above with regard to the guaranteed session history. The applet then uses the customer's private key to generate the digital signature for each record (i.e., encrypt the hash value). The digital signature is then returned to the presentation component 160 along with the certificate (containing the necessary public key and identification credentials). Each digital signature and certificate are then kept in the secure database storage 185 for later retrieval, if necessary, to prove that the customer digitally signed the underlying data used to generate the replayed pages. Similar to the process for guaranteeing session history, the digital signature and public key from the certificate can be used to enable the entity to reconstruct the viewed and digitally-signed web pages at a later date and prove, by comparing the hash value obtained from the digital signature with the hash value of the current record(s), that the data now used to generate the reconstructed pages have not been changed or tampered with subsequent to the digital signature by the customer. If desired, the relevant records may also be digitally signed by the entity, as described above with regard to guaranteed session history.

Functional Flow Analysis of Sessions

In yet another aspect of the present invention, alternative back end processes 198, as shown in FIG. 22, are performed to provide the entity with practical information regarding its end users and, more specifically, their interactions with the entity's web site. Such information, for example, enables the entity to detect potential problem areas within the web site that are experienced by a plurality of end users, enables the entity to identify particular needs or wants that a particular end user may have but not affirmatively made known to the entity, and enables the entity to provide more customized services and product offers to a particular end user based on preferences and past interactions the particular end user has had with the web site. These processes 198 include modified collaboration services component processes 2300 and pattern recognition processes 2400. Modified collaboration services component processes 2300 are called “modified” because they are somewhat similar to but different from the collaboration services component processes 500 (directed to replay of a web session to the CSR) and 500a (directed to replay of a web session to the end user), described previously in association with FIGS. 5c and 11. Instead, modified collaboration services component processes 2300 are directed only to those particular processes performed by the collaboration services component 150 that enable the collaboration server arrangement 190 to gather session data and identify click streams for a particular session being analyzed. The additional processing available from the collaboration services component 150 that is necessary to convert the stored session, request, and response records into viewable web pages is not necessary for this aspect of the invention. Preferably, this aspect of the invention is able to run continuously in the background, during specific data processing times, or as desired by the entity.

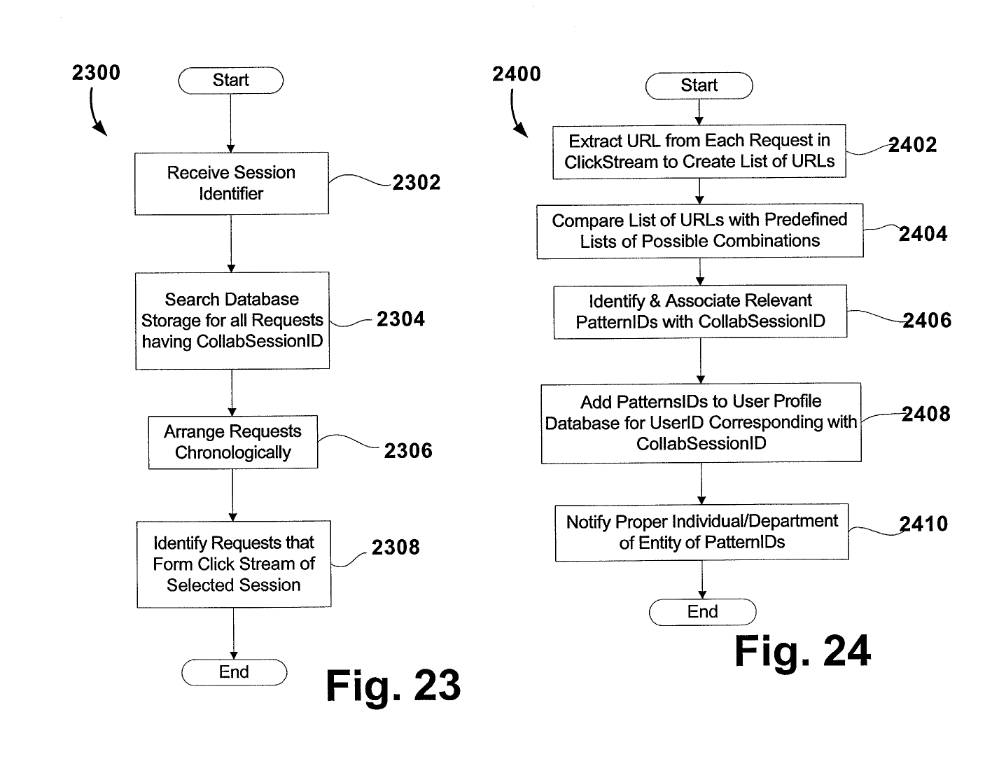

For example, as shown in FIG. 23, for this aspect of the invention, it is only necessary for the collaboration services component 150 to receive (Step 2302) a session identifier (CollabSessionID) for processing. Such session identifier may be provided thereto in any number of ways. For example, the collaboration services component 150 may run batch processing to initiate this aspect of the invention for a block of sessions maintained in the database storage 180, or for sessions identified by CollabSessionID range of numbers, SessionEndTime, UserID, EntityID, ApplSessionID, and the like. Regardless, once the component 150 receives a CollabSessionID for processing (in Step 2302), it next searches the database storage 180 for all requests associated with the CollabSessionID, arranges (Step 2306) them chronologically (if necessary), and then identifies (Step 2308) each request (primary request) that is part of the click stream for the session.

Turning now to FIG. 24, the pattern recognition process 2400, which is performed by the collaboration services component 150 or any other suitable data processing component (shown or otherwise) of the collaboration server arrangement 190, then extracts (Step 2402) the URL from each request from the click stream, which defines a list of URLs. Alternatively, each URL from this list of URLs is replaced with its respective base URLs (as calculated in Step 922 and described previously) or by its respective URLHash values (as calculated in Steps 936, 938). Next, this list of URLs is compared or otherwise analyzed (Step 2404) in relation to a plurality of predefined sequences, arrangements, and combinations of possible URLs (or potentially only those sequences, arrangements, and combinations of particular interest to the entity) available by end users accessing the relevant web site and affiliated application. Preferably, such comparison or analysis makes use of known pattern recognition algorithms. For each pattern recognized in Step 2404, the corresponding and predefined pattern identifier (PatternID) is associated (Step 2406) with the CollabSessionID. Such patternIDs are then added (Step 2408) to a user profile database and associated with the user (UserID) corresponding with the identified CollabSessionID. Finally, an alert or notification, as desired, is then sent (Step 2410) to the appropriate individual within the entity or designated by the entity, such as the CSR, marketing department, sales department, troubleshooting, etc. The number of possible patterns and applications with which such patterns may be of use or benefit are infinite.

For example, it may be of benefit to a financial institution to know that one of its customers has reviewed its credit card or mortgage lending information but not applied. It may be of benefit for any on-line company to know that many users begin the process of signing up for an account but do not complete such process and where within the web session. It may be of benefit to know when a registered user has attempted to access the login screen but been unsuccessful in remembering the correct password, even though the user did not request help with the password. Obviously, many other examples could be given and apply within the scope of this aspect of the present invention.

In view of the foregoing detailed description of preferred embodiments of the present invention, it readily will be understood by those persons skilled in the art that the present invention is susceptible of broad utility and application. While various aspects have been described in the context of HTML and web page uses, the aspects may be useful in other contexts as well. Many embodiments and adaptations of the present invention other than those herein described, as well as many variations, modifications, and equivalent arrangements, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. In addition, some steps may be carried out simultaneously. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

What is claimed is:

1. A method for monitoring a browser's interactions with a server arrangement, comprising the steps of:
(a) capturing information regarding http requests received at the server arrangement and corresponding http responses sent from the server arrangement, the information including,
(i) for each request, content of the request and a time of receipt for the request, and
(ii) content of the response corresponding to each such request;
(b) identifying sessions, each comprising requests received at the server arrangement and corresponding responses;
(c) assigning a session identification (SessionID) for each identified session; and
(d) recording in a database for each identified session the SessionID for such session in association with,
(i) the content of each respective request in the identified session,
(ii) the content of each respective response in the identified session, and
(iii) a chronological order of the requests in the identified session.

2. A method for monitoring browser interactions with a server arrangement, comprising the steps of.
(a) capturing information regarding http requests received from browsers at the server arrangement and corresponding http responses sent to the browsers from the server arrangement, the information including,
(i) for each request,
(A) content of the request,
(B) a time of receipt for the request, and
(C) a browser identification (BrowserID) associated with the request, and
(ii) content of the response corresponding to each such request, and
(b) identifying sessions for each BrowserID, each session comprising requests associated with such BrowserID that are received at the server arrangement within a predetermined period of time and corresponding responses;
(c) assigning a session identification (SessionID) for each identified session; and
(d) recording in a database for each identified session the SessionID for such session in association with,
(i) the content of each respective request in the identified session,
(ii) the content of each respective response in the identified session,
(iii) a chronological order of the requests in the identified session, and
(iv) the BrowserID for which the session is identified.

3. A method for monitoring browser interactions with a server arrangement for a website, comprising the steps of:
(a) capturing information regarding http requests received from browsers at the server arrangement and corresponding http responses sent to the browsers from the server arrangement, the information including,
(i) for each request,
(A) content of the request,
(B) a time of receipt for the request,
(C) a browser identification (BrowserID) associated with the request, and
(D) an entity identification (EntityID) associated with a uniform resource locator (URL) related to the request, and
(ii) content of the response corresponding to each such request;
(b) identifying sessions for each pair of BrowserID and EntityID, each session comprising,
(i) requests associated with such BrowserID and related to the URL associated with the EntityID that are received at the server arrangement within a predetermined period of time, and
(ii) corresponding responses;
(c) assigning a session identification (SessionID) for each identified session; and
(d) recording in a database for each identified session the SessionID for such session in association with,
(i) the content of each respective request in the identified session,
(ii) the content of each respective response in the identified session,
(iii) a chronological order of the requests in the identified session, and
(iv) the BrowserID and EntityID for which the session is identified.

4. The method of claims 1, 2, or 3, wherein said step of recording in the database for each identified session the chronological order of the requests in the identified session comprises recording in the database the time of receipt for each request in the identified session.

5. The method of claims 1, 2, or 3, wherein said step of identifying sessions includes identifying,
(a) requests, each of which is received at the server arrangement within a predetermined period of time of another such request, and
(b) responses corresponding to such requests.

6. The method of claim 5, wherein said step of identifying sessions further includes identifying a request as being chronologically the last request of the session if the request is for a resource predetermined to signify an end of a session.

7. The method of claims 1, 2, or 3, further comprising the steps of,
(a) obtaining a user identification (UserID) associated with a particular request, and
(b) recording the UserID in the database in association with the SessionID of the particular request.

8. The method of claim 7, wherein the UserID is obtained from an application server.

9. The method of claims 1, 2, or 3, further comprising the steps of,
(a) obtaining an application session identification (ApplicationSessionID) associated with a particular request, and
(b) recording the ApplicationSessionID in the database in association with the SessionID of the particular request.

10. The method of claim 9, wherein the ApplicationSessionID is obtained from an application server.

11. The method of claims 1, 2, or 3, further comprising, before said step of identifying sessions, first discarding,
(a) responses, each of which has a content type matching a predetermined content type, and
(b) each request corresponding to such response.

12. The method of claims 1, 2, or 3, further comprising, for each request for a resource predetermined to have sensitive input fields, first deleting data from such input fields before said step of recording the content of the request.

13. The method of claims 1, 2, or 3, wherein the database includes contents of previous responses recorded in association with respective hash values therefor, and further comprising the steps of,
(a) calculating a hash value for the content of a current response; and
(b) when the calculated hash value matches none of the recorded hash values, recording the content of the current response in the database and, in association therewith, recording the calculated hash value in the database.

14. The method of claim 13, wherein said step of recording the SessionID for each identified session in association with the content of each respective response in the identified session comprises the step of linking the SessionID with the recorded hash value for the content of each response in such identified session.

15. A computer network for performing the method of claims 1, 2, or 3, comprising:
(a) a server arrangement disposed for communication with a browser whereat said step of capturing is performed; and
(b) a database whereat said step of recording is performed.

16. The computer network of claim 15, further comprising a firewall in said computer network disposed between said server arrangement and said database.

17. The computer network of claim 15, wherein said server arrangement comprises a single server.

18. The computer network of claim 15, wherein said server arrangement comprises a plurality of servers.

19. The computer network of claim 18, wherein said step of capturing information is performed at each server of said plurality of servers.

20. The computer network of claim 19, wherein said computer network further comprises a collection component.

21. The computer network of claim 20, wherein the method further comprises the steps of, at each server of said plurality of servers,
(a) calculating a hash value for a response captured at that server;
(b) when the calculated hash value matches one of the reference hash values, forwarding from that server to said collection component the calculated hash value but not the content of the response; and
(c) when the calculated hash value matches none of the reference hash values, forwarding from that server to said collection component the calculated hash value for the content of the response and the content of the response.

22. The computer network of claim 20, wherein said step of identifying sessions is performed at said collection component.

23. The computer network of claim 20, further comprising a firewall disposed between said server arrangement and said collection component.

24. The method of claims 1, 2, or 3, further comprising the steps of,
(a) identifying each request for which a corresponding response is of a content type representing part of a click stream, and
(b) recording in the database whether a recorded request is so identified.

25. The computer network of claim 24, wherein said step of identifying each request for which a corresponding response is of a content type representing part of a click stream is performed at the server arrangement.

26. The computer network of claim 24, wherein the content type is text/html.

27. The computer network of claim 24, wherein said step of recording in the database whether a response recorded in the database is so identified comprises setting a flag maintained in the database in association with the request.

28. The method of claims 1, 2, or 3, wherein the content of each response is retained within a respective record of the database, and wherein said step of recording further comprises calculating a hash value for each such database record and then encrypting the calculated hash value with a private key of a public-private key pair.

29. The method of claim 28, wherein the public-private key pair is for an entity.

30. The method of claim 29, wherein the public-private key pair is for a user of a browser to which the record pertains.

31. The method of claims 1, 2, or 3, wherein the content of each request is retained within a respective record of the database, and wherein said step of recording further comprises calculating a hash value for each such database record and then encrypting the calculated hash value with a private key of a public-private key pair.

32. The method of claim 31, wherein the public-private key pair is for an entity.

33. The method of claim 31, wherein the public-private key pair is for a user of a browser to which the record pertains.

34. The method of claims 1, 2, or 3, wherein each SessionID is retained within a respective record of the database, and wherein said step of recording further comprises calculating a hash value for each such database record and then encrypting the calculated hash value with a private key of a public-private key pair.

35. The method of claim 34, wherein the public-private key pair is for an entity.

36. The method of claim 34, wherein the public-private key pair is for a user of a browser to which the record pertains.

37. The method of claims 2, or 3, wherein each BrowserID is retained within a respective record of the database, and wherein said step of recording further comprises calculating a hash value for each such database record and then encrypting the calculated hash value with a private key of a public-private key pair.

38. The method of claim 37, wherein the public-private key pair is for an entity.

39. The method of claim 37, wherein the public-private key pair is for a user of a browser to which the record pertains.

40. The method of claim 3, wherein each EntityID is retained within a respective record of the database, and wherein said step of recording further comprises calculating a hash value for each such database record and then encrypting the calculated hash value with a private key of a public-private key pair.

41. The method of claim 40, wherein the public-private key pair is for an entity.

42. The method of claim 40, wherein the public-private key pair is for a user of a browser to which the record pertains.

43. A method of creating content of a response enabling a browser to generate a page from information recorded in a database regarding past browser interactions with a server arrangement, the browser interactions comprising primary and subordinate http requests received at the server arrangement and corresponding primary and subordinate http responses sent from the server arrangement, the information including,
(i) for each request, content of the request and, in association therewith, content of the response corresponding to such request, and
(ii) a chronological order of the requests received at the server arrangement, the method comprising the steps of:
(a) parsing the content of a primary response recorded in the database to identify uniform resource locators (URLs) contained therein, and
(b) for a URL so identified, locating in the content recorded in the database of subordinate requests received at the server arrangement prior to the next primary request a URL matching the identified URL, and upon a match, replacing the identified URL in the content of the primary response with a database pointer directed to the content recorded in the database for the subordinate response corresponding to such subordinate request having the matching URL.

44. A method of creating content of a response enabling a browser to generate a page from information recorded in a database regarding past browser interactions with a server arrangement, the browser interactions comprising primary and subordinate http requests received at the server arrangement from browsers and corresponding primary and subordinate http responses sent from the server arrangement to the browsers, the page representative of past browser interactions of a particular browser, the information recorded in the database including,
(i) for each request, content of the request and, in association therewith, content of the response corresponding to such request and a browser identification (BrowserID) for the request, the BrowserID being unique to a browser,
(ii) a chronological order of the requests received at the server arrangement, the method comprising the steps of:
(a) parsing the content of a primary response recorded in the database to identify uniform resource locators (URLs) contained therein, the primary response being associated with the BrowserID of the particular browser;
(b) for a URL so identified, locating in the content recorded in the database of subordinate requests received at the server arrangement prior to the next primary request a URL matching the identified URL, and upon a match, replacing the identified URL in the content of the primary response with a database pointer directed to the content recorded in the database for the subordinate response corresponding to such subordinate request having the matching URL.

45. The method of claim 44, wherein the database further includes recorded therein, in association with each request, a session identification (SessionID) for a session in which the request was received at the server arrangement, each SessionID being unique to a session.

46. The method of claim 45, wherein the page further represents past browser interactions of the particular browser in a particular session, and the primary response for which the content is parsed is associated with the SessionID of the particular session.

47. The method of claim 44, wherein the database further includes recorded therein, in association with each request, an entity identification (EntityID) on whose behalf the corresponding response is made, each EntityID being unique to an entity.

48. The method of claim 47, wherein the page further represents past browser interactions of the particular browser with regard to a particular entity, and the primary response for which the content is parsed is associated with the EntityID of the particular entity.

49. The method of claim 44, wherein the database further includes recorded therein, in association with each request, an application session identification (ApplicationSessionID) for an application session, each ApplicationSessionID being unique to an application session.

50. The method of claim 49, wherein the page further represents past browser interactions of the particular browser in a particular application session, and the primary response for which the content is parsed is associated with the ApplicationSessionID of the particular application session.

51. The method of claim 44, wherein the database further includes recorded therein, in association with each request, a user identification (UserID) for a user of the particular browser, each UserID being unique to a user.

52. The method of claim 51, wherein the page further represents past browser interactions of the particular browser by a particular user, and the primary response for which the content is parsed is associated with the UserID of the particular user.

53. The method of claims 43 or 44, further comprising the step of modifying the content of the parsed primary response to deactivate hypertext that would otherwise be included in the page.

54. The method of claims 43 or 44, further comprising the step of identifying a form source URL in the content of the parsed primary response and a matching target source URL in the content of a subsequent request recorded in the database, and associating the response content with the request content.

55. The method of claims 43 or 44, further comprising the step of identifying a form source URL in the content of the parsed primary response and a matching target source URL in the content of a subsequent request recorded in the database, and modifying the content of the response to include data from the content of the request such that the page generated by the browser comprises a form-filled page.

56. The method of claim 55, wherein the page comprises a complete form-filled page.

57. The method of claims 43 or 44, wherein the parsed primary response includes a content type of text/html.

58. The method of claims 43 or 44, wherein the content of each response is retained within a respective record of the database together with a digital signature for such record, and further comprising the step of verifying the record with a public key of a public-private key pair.

59. The method of claim 58, wherein the public-private key pair is for an entity.

60. The method of claim 58, wherein the public-private key pair is for a user of a browser to which the record pertains.

61. The method of claims 43 or 44, wherein the content of each request is retained within a respective record of the database together with a digital signature for such record, and further comprising the step of verifying the record with a public key of a public-private key pair.

62. The method of claim 61, wherein the public-private key pair is for an entity.

63. The method of claim 61, wherein the public-private key pair is for a user of a browser to which the record pertains.

64. The method of claim 44, wherein each BrowserID is retained within a respective record of the database together with a digital signature for such record, and further comprising the step of verifying the record with a public key of a public-private key pair.

65. The method of claim 64, wherein the public-private key pair is for an entity.

66. The method of claim 64, wherein the public-private key pair is for a user of a browser to which the record pertains.

67. The method of claim 45, wherein each SessionID is retained within a respective record of the database together with a digital signature for such record, and further comprising the step of verifying the record with a public key of a public-private key pair.

68. The method of claim 67, wherein the public-private key pair is for an entity.

69. The method of claim 67, wherein the public-private key pair is for a user of a browser to which the record pertains.

70. The method of claim 47, wherein each EntityID is retained within a respective record of the database together with a digital signature for such record, and further comprising the step of verifying the record with a public key of a public-private key pair.

71. The method of claim 70, wherein the public-private key pair is for the entity of the EntityID.

72. The method of claim 70, wherein the public-private key pair is for a user of a browser to which the record pertains.

73. The method of claim 49, wherein each ApplicationSessionID is retained within a respective record of the database together with a digital signature for such record, and further comprising the step of verifying the record with a public key of a public-private key pair.

74. The method of claim 73, wherein the public-private key pair is for an entity.

75. The method of claim 73, wherein the public-private key pair is for a user of a browser to which the record pertains.

76. The method of claim 49, wherein each UserID is retained within a respective record of the database together with a digital signature for such record, and further comprising the step of verifying the record with a public key of a public-private key pair.

77. The method of claim 76, wherein the public-private key pair is for an entity.

78. The method of claim 76, wherein the public-private key pair is for the user of the UserID.

79. A method of viewing a page representative of past browser interactions of a particular browser with a server arrangement, comprising the steps of:
(I) monitoring browser interactions of a plurality of browsers, including the particular browser, with the server arrangement, including,
(a) capturing information regarding primary and subordinate http requests received from the browsers at the server arrangement and corresponding primary and subordinate http responses sent to the browsers from the server arrangement, the information including,
(i) for each request,
(A) content of the request,
(B) a time of receipt for the request, and
(C) a browser identification (BrowserID) associated with the request, the BrowserID being unique to each browser, and
(ii) content of the response corresponding to each such request, and
(b) identifying sessions for each BrowserID, each session comprising requests associated with such BrowserID that are received at the server arrangement within a predetermined period of time and corresponding responses;
(c) assigning a session identification (SessionID) for each identified session;
and
(d) recording in a database for each identified session the SessionID for such session in association with,
(i) the content of each respective request in the identified session,
(ii) the content of each respective response in the identified session,
(iii) a chronological order of the requests in the identified session, and
(iv) the BrowserID for which the session is identified;
(II) creating content of a response, including,
(a) parsing the content of a primary response recorded in the database to identify uniform resource locators (URLs) contained therein, the primary response being associated with the BrowserID of the particular browser; and
(b) for a URL so identified, locating in the content recorded in the database of subordinate requests received at the server arrangement prior to the next primary request a URL matching the identified URL, and upon a match, replacing the identified URL in the content of the primary response with a database pointer directed to the content recorded in the database for the subordinate response corresponding to such subordinate request having the matching URL; and
(III) sending the created content of the response to a reviewing browser for generation of the page.

80. The method of claim 79, further comprising originating a digital signature at the reviewing browser for the page viewed.

81. The method of claim 80, wherein the digital signature is originated using a private key of a public-private key pair of a user of the reviewing browser.

82. A method of rendering assistance by a customer service representative (CSR) to a user of a particular browser interacting with a web server arrangement, comprising the steps of,
(I) monitoring browser interactions of a plurality of browsers, including the particular browser, with the server arrangement, including,
(a) capturing information regarding primary and subordinate http requests received from the browsers at the server arrangement and corresponding primary and subordinate http responses sent to the browsers from the server arrangement, the information including,
(i) for each request,
(A) content of the request,
(B) a time of receipt for the request, and
(C) a browser identification (BrowserID) associated with the request, the BrowserID being unique to each browser, and
(ii) content of the response corresponding to each such request, and
(b) identifying sessions for each BrowserID, each session comprising requests associated with such BrowserID that are received at the server arrangement within a predetermined period of time and corresponding responses;
(c) assigning a session identification (SessionID) for each identified session; and
(d) recording in a database for each identified session the SessionID for such session in association with,
(i) the content of each respective request in the identified session,
(ii) the content of each respective response in the identified session,
(iii) a chronological order of the requests in the identified session, and
(iv) the BrowserID for which the session is identified;
(II) viewing by the CSR on a CSR browser a page representative of past browser interactions of the particular browser of the user with the server arrangement, comprising the steps of:
(a) creating content of a response, including,
(i) parsing the content of a primary response recorded in the database to identify uniform resource locators (URLs) contained therein, the primary response being associated with the BrowserID of the particular browser; and
(ii) for a URL so identified, locating in the content recorded in the database of subordinate requests received at the server arrangement prior to the next primary request a URL matching the identified URL, and upon a match, replacing the identified URL in the content of the primary response with a database pointer directed to the content recorded in the database for the subordinate response corresponding to such subordinate request having the matching URL; and
(b) displaying the page on the CSR browser upon receipt by the CSR browser of a response having the created content; and
(III) providing guidance by the CSR to the user based on the viewing of the page by the CSR.

83. The method of claim 82, wherein the guidance is provided by the CSR in near real time.

84. The method of claim 82, wherein the guidance is provided by the CSR offline.

85. The method of claim 82, wherein the guidance is provided by the CSR via telephone.

86. The method of claim 82, wherein the guidance is provided by the CSR via email.

87. The method of claim 82, wherein guidance is provided by the CSR via Internet chat.

88. The method of claims 79 or 82, further comprising the steps of,
(a) obtaining a user identification (UserID) associated with a particular request, and
(b) recording the UserID in the database in association with the SessionID of the particular request.

89. The method of claim 88, wherein the UserID is obtained from an application server.

90. The method of claims 79 or 82, further comprising the steps of,
(a) obtaining an application session identification (ApplicationSessionID) associated with a particular request, and
(b) recording the ApplicationSessionID in the database in association with the SessionID of the particular request.

91. The method of claim 90, wherein the ApplicationSessionID is obtained from an application server.

92. The method of claims 79 or 82, further comprising, before said step of identifying sessions, first discarding,
(a) responses, each of which has a content type matching a predetermined content type, and
(b) each request corresponding to such response.

93. The method of claims 79 or 82, further comprising, for each request for a resource predetermined to have sensitive input fields, first deleting data from such input fields before said step of recording the content of the request.

94. The method of claims 79 or 82, wherein the database includes contents of previous responses recorded in association with respective hash values therefor, and further comprising the steps of,
(a) calculating a hash value for the content of a current response; and
(b) when the calculated hash value matches none of the recorded hash values, recording the content of the current response in the database and, in association therewith, recording the calculated hash value in the database.

95. A computer network for performing said step of monitoring of claims 79 or 82, comprising:
(a) a server arrangement disposed for communication with a browser whereat said step of capturing is performed;
(b) a database whereat said step of recording is performed; and
(c) a firewall disposed between said server arrangement and said database.

96. The computer network of claim 95, wherein said server arrangement comprises a single server.

97. The computer network of claim 95, wherein said server arrangement comprises a plurality of servers.

98. The computer network of claim 97, wherein said step of capturing information is performed at each server of said plurality of servers.

99. The computer network of claim 98, wherein said computer network further comprises a collection component.

100. The computer network of claim 99, wherein the method further comprises the steps of, at each server of said plurality of servers,
(a) calculating a hash value for a response captured at that server;
(b) when the calculated hash value matches one of the reference hash values, forwarding from that server to said collection component the calculated hash value but not the content of the response; and
(c) when the calculated hash value matches none of the reference hash values, forwarding from that server to said collection component the calculated hash value for the content of the response and the content of the response.

101. The computer network of claim 99, wherein said step of identifying sessions is performed at said collection component.

102. The computer network of claim 99, further comprising a firewall disposed between said server arrangement and said collection component.

103. The method of claims 79 or 82, wherein the page further represents past browser interactions of the particular browser in a particular session, and the primary response for which the content is parsed is associated with the SessionID of the particular session.

104. The method of claims 79 or 82, wherein the web server arrangement services web sites of a plurality of entities and wherein the database further includes recorded therein, in association with each request, an entity identification (EntityID) unique to each entity.

105. The method of claim 104, wherein the page further represents past browser interactions of the particular browser with regard to a particular entity, and the primary response for which the content is parsed is associated with the EntityID of the particular entity.

106. The method of claims 79 or 82, wherein the database further includes recorded therein, in association with each request, an application session identification (ApplicationSessionID) for an application session, each ApplicationSessionID being unique to an application session.

107. The method of claim 106, wherein the page further represents past browser interactions of the particular browser in a particular application session, and the primary response for which the content is parsed is associated with the ApplicationSessionID of the particular application session.

108. The method of claims 79 or 82, wherein the database further includes recorded therein, in association with each request, a user identification (UserID) for a user of the particular browser, each UserID being unique to a user.

109. The method of claim 108, wherein the page further represents past browser interactions of the particular browser by a particular user, and the primary response for which the content is parsed is associated with the UserID of the particular user.

110. The method of claims 79 or 82, further comprising the step of modifying the content of the parsed primary response to deactivate hypertext that would otherwise be included in the page.

111. The method of claim 110, further comprising the step of identifying a form source URL in the content of the parsed primary response and a matching target source URL in the content of a subsequent request recorded in the database, and associating the response content with the request content.

112. The method of claims 79 or 82, further comprising the step of identifying a form source URL in the content of the parsed primary response and a matching target source URL in the content of a subsequent request recorded in the database, and modifying the content of the response to include data from the content of the request such that the page generated by the browser comprises a form-filled page.

113. The method of claim 112, wherein the page comprises a complete form-filled page.

114. The method of claims 79 or 82, wherein the parsed primary response includes a content type of text/html.

115. A method for monitoring a browser's interactions with a server arrangement, comprising the steps of:
(a) capturing information regarding primary and subordinate http requests received at the server arrangement and corresponding primary and subordinate http responses sent from the server arrangement, the information including,
(i) for each request, content of the request, and
(ii) content of the response corresponding to each such request;
(b) recording in a database,
(i) the content of each respective request,
(ii) the content of each respective response, and
(iii) a chronological order of the requests;
(c) parsing the content of primary requests recorded in the database to identify uniform resource locators (URLs) contained therein; and
(d) taking a predefined action in response to the recognition of a predetermined pattern of identified URLs contained with the content of the primary requests.

116. A method for monitoring a browser's interactions with a server arrangement, comprising the steps of.
(a) capturing information regarding primary and subordinate http requests received at the server arrangement and corresponding primary and subordinate http responses sent from the server arrangement, the information including,
(i) for each request, content of the request and a time of receipt for the request, and
(ii) content of the response corresponding to each such request; and
(b) identifying sessions, each comprising requests received at the server arrangement and corresponding responses;
(c) assigning a session identification (SessionID) for each identified session;
(d) recording in a database for each identified session the SessionID for such session in association with,
(i) the content of each respective request in the identified session,
(ii) the content of each respective response in the identified session, and
(iii) a chronological order of the requests in the identified session; and
(e) for a particular SessionID, parsing the content of primary requests recorded in the database in association with such SessionID to identify uniform resource locators (URLs) contained therein, and
(f) taking a predefined action in response to the recognition of a predetermined pattern of identified URLs contained with the content of the primary requests.

117. A method for monitoring a browser's interactions with a server arrangement, comprising the steps of:
(a) capturing information regarding primary and subordinate http requests received at the server arrangement and corresponding primary and subordinate http responses sent from the server arrangement, the information including,
(i) for each request,
(A) content of the request,
(B) a time of receipt for the request, and
(C) a browser identification (BrowserID) associated with the request, and
(ii) content of the response corresponding to each such request;
(b) identifying sessions for each BrowserID, each comprising requests associated with such BrowserID that are received at the server arrangement within a predetermined period of time and corresponding responses;
(c) assigning a session identification (SessionID) for each identified session;
(d) recording in a database for each identified session the SessionID for such session in association with,
(i) the content of each respective request in the identified session,
(ii) the content of each respective response in the identified session,
(iii) a chronological order of the requests in the identified session, and
(iv) the BrowserID for which the session is identified;
(e) for a particular BrowserID, parsing the content of primary requests recorded in the database in association with such BrowserID to identify uniform resource locators (URLs) contained therein; and
(f) taking a predefined action in response to the recognition of a predetermined pattern of identified URLs contained with the content of the primary requests.

118. The method of claims 115, 116, or 117, wherein the predefined pattern comprises a chronological sequence of URLs.

119. The method of claims 115, 116, or 117, wherein the predetermined action comprises notifying a customer service representative of the recognition of the predetermined pattern.

120. The method of claims 115, 116, or 117, wherein the predetermined action comprises assigning a pattern identification (PatternID) corresponding to the URL pattern recognized and recording the PatternID in the database.

121. A computer network for performing the method of claims 115, 116, or 117, comprising:
(a) a server arrangement disposed for communication with a browser whereat said step of capturing is performed; and
(b) a database whereat said step of recording is performed.

122. The computer network of claim 121, further comprising a firewall in said computer network disposed between said server arrangement and said database.

123. The computer network of claim 122, wherein said server arrangement comprises a single server.

124. The computer network of claim 122, wherein said server arrangement comprises a plurality of servers.

125. The computer network of claim 124, wherein said step of capturing information is performed at each server of said plurality of servers.

126. The computer network of claim 125, wherein said computer network further comprises a collection component whereat said step of identifying sessions is performed.

127. The computer network of claim 126, further comprising a firewall disposed between said server arrangement and said collection component.

128. Computer-readable medium having computer-executable instructions that perform the steps of the method of claims 1, 2, 3, 43, 44, 79, 115, 116, or 117.
